(19) United States
(12) Patent Application Publication
(10) Pub. No.: US 2016/0354283 A1
(43) Pub. Date: Dec. 8, 2016

(54) SENSOR-BASED MEDICATION SYSTEMS

(71) Applicant: Nuvizen, Palo Alto, CA (US)

(72) Inventors: BeLong CHO, Seoul (KR); Chang-Min PAK, Palo Alto, CA (US); Hochun CHOI, Seoul (KR); MinSung KWON, San Jose, CA (US)

(21) Appl. No.: 15/164,533

(22) Filed: May 25, 2016

Related U.S. Application Data
(60) Provisional application No. 62/170,627, filed on Jun. 3, 2015.

(51) Int. Cl. A61J 7/02; H04N 7/18; A61J 7/04; A61J 7/00

(52) U.S. Cl. CPC A61J 7/02; A61J 7/0076; H04N 7/181; A61J 7/04; A61J 2200/30

(57) ABSTRACT

Described herein are various sensor-based medication storage and dosage tracking systems, comprising a base unit with a visual display, and at least one receptacle to receive one or more pill containers. Sensors in the system are configured to detect medication removal from the pill containers as the pill containers remain in the receptacle, and are configured to automatically track medication usage and amount, and to provide medication reminders to the user. The system may be configured to communicate with other personal devices, including cell phones and personal computers, as well as remote servers or electronic health care record systems, and may be further to provide notifications to and from third parties as they relate to medication compliance or other healthcare activities.

### CROSS-REFERENCE TO RELATED APPLICATION

This application claims priority under 35 U.S.C. §119(e) to U.S. Provisional Patent Application No. 62/170,627 filed on Jun. 3, 2015, which is incorporated by reference herein in its entirety.

### BACKGROUND

Medication non-adherence is a major source of poor health outcomes, but remains a complex, multi-factorial problem in healthcare. One study reported that about a quarter of patients do not even fill their prescriptions within 7 days of hospital discharge, about a third of patients will stop at least one medication with one month of discharge, with about ten percent of patients stopping all medications within one month.

Medication adherence is especially difficult in elderly patients with multiple chronic diseases; the usage of multiple drugs can be difficult to coordinate on a daily basis. Physicians tasked with optimization of medication regimens are also challenged by the lack of patient compliance information, and may be inadvertently increasing dosages or changing drug regimens due to inadequate outcome, when medication non-compliance may be the source of the treatment failure. Compliance information is also useful in a multi-disciplinary care setting, where it may be an indicator of home health needs and living assistance requirements in an aging population.

### SUMMARY

Described herein are various sensor-based medication storage and dosage tracking systems, comprising a base unit with a visual display, and at least one receptacle to receive one or more pill containers. Sensors in the system are configured to detect medication removal from the pill containers as the pill containers remain in the receptacle, and the system is configured to automatically track medication usage and amount, and to provide medication reminders to the user. The system may be configured to communicate with other personal devices, including cell phones and personal computers, as well as remote servers, health tracking devices, other connected healthcare devices such as glucose monitors and inhalers, electronic health care record systems or personal health data sites or software, and may be further configured to provide notifications to and from third parties as they relate to medication compliance or other healthcare activities.

In one embodiment, a medicament system is provided, comprising a pill container storage unit, the unit comprising a base with at least one receptacle configured to receive at least one pill container, a lid with an external surface and an internal surface, the lid configured to reversibly open and close to cover the at least one receptacle, a sensor system, a visual display, and a control system configured to receive sensor input from the sensor system and provide output to the visual display, wherein the sensor system is configured to detect the presence or absence of the at least one pill container in the at least one receptacle, movement within at least one pill container when the at least one pill container is stationed in the at least one receptacle, and the open or closed state of at least one of the lid and the at least one pill container. The sensor system may be further configured to detect the amount of pills in the at least one pill container. The display may be located on the inner surface of the lid. The lid and the base may be movably coupled by a hinge mechanism. The container storage unit may further comprise an external indicator, the indicator comprising an optical indicator or a tactile indicator. The indicator may comprise an optical indicator located on an external surface of the base or the external surface of the lid. The sensor system may be configured to obtain pill information from the at least one pill container. The visual display may comprise a first edge configured with a first edge length that spans across at least a portion of each of the at least one receptacles. The visual display may be a touchscreen display. The sensor system may comprise an RFID or optical sensor. The optical sensor may comprise a refractive or diffractive element. The sensor system may comprises at least one optical sensor located in a bottom wall of the at least one receptacle, and wherein the at least one optical sensor located in the bottom wall may be configured to detect the at least one of the presence and absence of the at least one pill container in the at least one receptacle, and the movement within the at least one pill container when stationed in the at least one receptacle. The bottom wall may be a flat bottom wall, and wherein the at least one receptacle may further comprise a concave anterior wall. The sensor system may comprise at least one sensor located in an anterior wall of the at least one receptacle. The at least one sensor located in the anterior wall may be configured to detect the movement within the at least one pill container, when the at least one pill container is stationed in the at least one receptacle. The optical sensor may be located in a concave anterior wall of the at least one receptacle. The sensor system may further comprise at least one posterior optical sensor in a posterior wall of the at least one receptacle. The at least one posterior optical sensor may be configured to read an identifier associated with the at least one pill container when placed in one of the at least one receptacles. The sensor system may further comprise a camera element located on the lid. The camera element maybe configured to detect at least one of the open or closed state of the lid, the presence or absence of the at least one pill container in the at least one receptacle, and an identifier associated with at least one pill container, and a signal corresponding to pill removal from the at least one pill container or to pill intake by a user. The sensor system comprises an ambient light sensor. The sensor system may comprise sensors located in a bottom wall and an anterior wall of the at least one receptacle. Said sensors may be configured to detect the movement within at least one pill container, when the at least one pill container is stationed in the at least one receptacle. Said sensors may be configured to detect the open or closed state of the at least one pill container. The sensor system may comprise at least one mechanical sensor located in the at least one receptacle, wherein said at least one mechanical sensor may be configured to detect the presence or absence of the at least one pill container in the at least one receptacle. The signal corresponding to pill removal may be a signal corresponding to movement in the at least one pill container while the at least one pill container is stationed in the at least one receptacle. The camera element may be configured to detect at least one of a hand and a mouth location of a user. The medicament system may further comprise a communication module configured to communicate with a remote server or a separate computing device. The medicament system may further comprise a pill container configured to reside in the at least one receptacle. The pill container may comprise a flat bottom wall, an upper opening and an anterior wall that has an inner concave curvature. The sensor system may be further configured to detect an identifier associated with at least one pill container.

In another embodiment, a container is provided, comprising a wall with an outer surface, an inner surface, and cavity surrounded by the inner surface, an optical sensor with a diffractive grating, wherein the optical sensor is coupled to the wall and facing into the cavity, wherein the sensor is configured to optically detect at least one characteristic of the content of the cavity, an electronic communication module configured to send and receive remote information corresponding to the content, a controller configured to selectively provide a notification corresponding to the remote information, a power supply system configured to power the optical sensor and the communication module. The notification may be an electronic notification sent by the electronic communication module to a wireless communication device, and/or an optical notification mounted on the outer surface of the wall. The at least one characteristic may comprise a fluid viscosity, movement of any contents of the cavity, a fluid opacity, a fluid level and/or a fluid color.

In another embodiment, a method of managing treatment is provided, comprising detecting an opening of an electronic pillbox, providing a visual display inside the electronic pillbox indicating a pill container region from a plurality of pill container regions in the pillbox to take a pill. The method may further comprise providing an external notification from an electronic pillbox to a user to take a pill. The visual display may further indicate the number of pills to take from the pill container region. The method may further comprise detecting a signal indicative of the amount of pills in a pill container region, and providing information on the visual display corresponding to the signal. The method may further comprise detecting placement of a pill container into a pill container region. The method may further comprise detecting an identifier associated with the pill container. The method may further comprise providing a calibration to the signal indicative of the amount of pills in a pill container region, wherein the calibration corresponds to the identifier. The method may further comprise detecting movement within the pill container region indicative of pill removal from the pill container region. Detecting movement may be performed using a sensor array located about the pill container region.

### BRIEF DESCRIPTION OF THE FIGURES

FIGS. 1A-1C are perspective views of an electronic pillbox, according to one embodiment.

FIG. 2 is a perspective view of an electronic pillbox, according to one embodiment.

FIG. 3 is a cross-sectional view of a portion of a pill container and the electronic pillbox of FIG. 2.

FIGS. 4A-4I are representative screens of a visual display, according to one embodiment.

FIGS. 5A and 5B are perspective views of a pill container, according to one embodiment.

FIGS. 6A and 6B are perspective views of a variation of a pill container, according to one embodiment.

FIG. 7 is a perspective view of a pill container set, according to one embodiment.

FIG. 8 is a perspective view of a pill container, according to one embodiment.

FIG. 9 is a flowchart illustrating a method for obtaining detailed medication information, according to one embodiment.

FIG. 10 is a flowchart illustrating a method for obtaining medication interaction information, according to one embodiment.

FIG. 11 is a flowchart illustrating a method for updating software and firmware on an electronic pillbox, according to one embodiment.

FIG. 12A is a flowchart illustrating a method for determining if one or more pills have been removed from a pill container, according to one embodiment.

FIG. 12B is a flowchart illustrating a method for responding when one or more pills have been removed, according to one embodiment.

FIG. 13 is a perspective view of a sensor-based container, according to one embodiment.

### DETAILED DESCRIPTION

Embodiments relate to facilitating and monitoring self-administration of medication. A pill container storage unit may include one or more sensors. Medication may be organized and stored in separate pill containers or cartridges, and these pill containers may be retained in an electronic medical monitoring system or pillbox. The electronic pillbox may be embodied as hardware and software that may perform a variety of functions, at least some of which may facilitate safe and compliant self-administration of medication. For example, the hardware and/or software of the electronic pillbox may obtain information related to a medication (e.g., the generic name and/or trade name, prescribed dose, dosage schedule, side effects, warnings, drug interactions, etc.), determine if a pill has been removed from the pill container, determine if a pill has been taken by a user, and/or track and record compliance information. A sensor system that communicates with a control system may allow at least some of the functions of the electronic pillbox to be performed automatically, without user input. The electronic pillbox may provide tactile, audio, and/or visual output, such as with a visual display, to convey information to the user. For example, the electronic pillbox may provide reminders when a pill should be taken and/or display information related to a medication. The electronic pillbox may comprise a communication module that may be capable of communicating with one or more remote devices or servers in order to obtain or deliver information. For example, the communication module may permit the electronic pillbox to access a medication database via a network (e.g., the Internet) to obtain detailed medication information and/or deliver compliance information to a user, caretaker, family member and/or healthcare provider.

Methods for managing treatment using the medication system are also described herein. In some variations, the electronic pillbox may detect placement of a pill container into a receptacle of the electronic pillbox and detect an identifier associated with that pill container. Detecting the identifier may allow the electronic pillbox to obtain or confirm information about the pill, including information that may be contained in the identifier itself, information that may be located in the internal memory of the electronic pillbox, or information that may be located in a remote server. The methods may also comprise the electronic pillbox detecting one or more signals that indicate the amount of pills in each receptacle or pill container and providing that information in real-time to a user using a graphical user display. The electronic pillbox may alert the user when a pill is due to be taken, and this alert may be provided visually, audibly, and/or tactilely from the electronic pillbox itself and/or from an external device, such as a mobile phone, that may receive a signal from the electronic pillbox. The electronic pillbox may also detect when a pill has been removed from a pill container and when the pill has been taken by the user.

In addition to tracking and providing reminders for medications stored within the electronic medical system, the system may also be used to track the usage of medication that is not stored in the system (e.g., inhalers, injectable medications, liquid medications, or other therapies) and/or to manage other health information (e.g., appointments, exercise regimens, therapy sessions).

In embodiments involving communications with remote servers, the system may be configured to provide logs of various tracked events, e.g., dates and times of medication intake, as well as summary information, e.g., percent of overall compliance, weekend compliance, morning compliance, etc. This information may be transmitted periodically (e.g., weekly or monthly) and/or event-driven (e.g., prior to a physician office visit), and may be proprietary or compliant with various electronic health record standards, such as HL7, or electronic healthcare record systems such as EPIC.

### System Overview

The sensor-based medication systems described here include an electronic pillbox configured to interact with one or more pill containers that may hold medication. The electronic pillbox may comprise a base, a lid, a visual display, a sensor system, and a control system. The base includes at least one receptacle configured to receive at least one pill container. The base may be movably attached to the lid, such as with a hinge, and the lid may be moved between closed and open positions. When the lid is in the closed position, the receptacle of the base may be covered, and when the lid is in the open position, the receptacle may be exposed to allow a user to access the one or more pill containers. The lid may include an external surface and an internal surface, and the visual display may be positioned on one or both of these surfaces. The visual display may present a variety of information to a user, such as a medication name, a medication indication, side effects of a medication, reminders to take a pill, the remaining number of pills in a pill container, and/or medication compliance information. In some variations, the display may be a touchscreen configured to accept input from the user.

The electronic pillbox may further include a sensor system that may include one or more sensors and one or more sensor types, such as optical or imaging sensors (e.g., camera elements, proximity sensors, motion sensors, infrared sensors, lensless smart sensors with or without built-in light, or the like), tactile sensors (e.g., force sensors, pressure sensors, other touch-sensitive sensors, or the like), mechanical sensors, electrical contact sensors, wireless signal sensors, and/or any other suitable sensor type. The sensors may be positioned in a variety of locations on the electronic pillbox, such as in the at least one receptacle, the lid and/or pill container. The sensors may be configured to detect or measure one or more signals or types of information, such as motion within a certain region, and/or the reflectance of components in a region, for example. In some variations different sensors may detect different signals or information. For example, some sensors of the sensor system may be configured to detect when the lid is open or closed, and other sensors may be configured to detect the presence or absence of a pill container in a receptacle and/or the number of pills remaining in a pill container. In some variations, the sensor system may be configured to detect a signal corresponding to pill removal from a pill container and/or pill intake by a user. Additionally or alternatively, the sensor system may be configured to obtain pill information from a pill container identifier, such as the generic name and/or trade name, the prescribed dose, dosage schedule, side effects, warnings and/or medication interactions, for example. Generally, a sensor may detect a signal or a change in the environment and produce an output, such as an electrical signal.

The electronic pillbox may include a control system configured to receive input from one or more sources, such the sensor system, a communication module, and/or user input sources (e.g., a touchscreen, touchpad, joystick, virtual keyboard, physical keyboard, microphone for voice input). The control system may be configured to provide output to one or more destinations, including, but not limited to the visual display and/or the communication module. The control system may include, for example, one or more processing units (CPU's), memory, and an input/output subsystem to communicate with the sensors, display and various communication modules, e.g., USB (e.g., USB-A, USB-C, micro-USB and mini-USB), Bluetooth, NFC, 802.11xx, GSM, CDMA, OFDM, etc. The one or more communication modules may be configured to communicate with a remote server or device, such as a mobile phone or computer, and exchange information with the control system. In addition, the electronic pillbox may include a power system for powering various components. The power system may include, for example, a power management system, one or more power sources (e.g., battery, alternating current (AC)), a recharging system, a power failure detection circuit, a power converter or inverter, a power status indicator (e.g., a light-emitting diode (LED)), and/or an optional charging system, including, USB chargers, or cordless or wireless charging, for example.

A sensor-based medication system may include one or more pill containers that hold one or more medications. While the pill containers are described as containing one or more pills, it should be appreciated that a pill container may contain any suitable form of a medication (e.g., liquid, inhaled, injectable). In some variations, a pill container suitable for use with the electronic pillbox described here may be any of a variety of standard prescription, over-the-counter (OTC) medication, or complementary and alternative medicine (CAM) containers. In other variations, the pill container may include one or more custom features that may facilitate interaction with the electronic pillbox. For example, the pill container may include a size and shape configured to at least partially fit into a receptacle of the electronic pillbox. In some variations, the pill container may include one or more identifiers, such as a barcode (e.g., linear barcodes, two dimensional or matrix barcodes), identifying number (e.g., National Drug Codes), RFID tag, identifying text (e.g., standard identifying text on a pill container), and/or the like that is detectable and readable by the electronic pillbox sensor system and/or control system. The pill container may additionally or alternatively include one or more features to allow the sensor system of the electronic pillbox to detect a signal associated with removal of a pill from the pill container. For example, the pill container may include one or more transparent portions, through which a sensor may detect movement of a pill, insertion of a finger to remove a pill, the number of pills, or changes in the surface area occupied by the pills. It should be appreciated that an electronic pillbox may be configured for use with more than one variation of pill container. For example, the sensor system may be configured to detect various types of medication containers (e.g., tablet container, inhaler, liquid medication dispenser), and utilize a different sensing modality to monitor usage and/or a remaining dosage of medication in that medication container.

### Electronic Pillbox

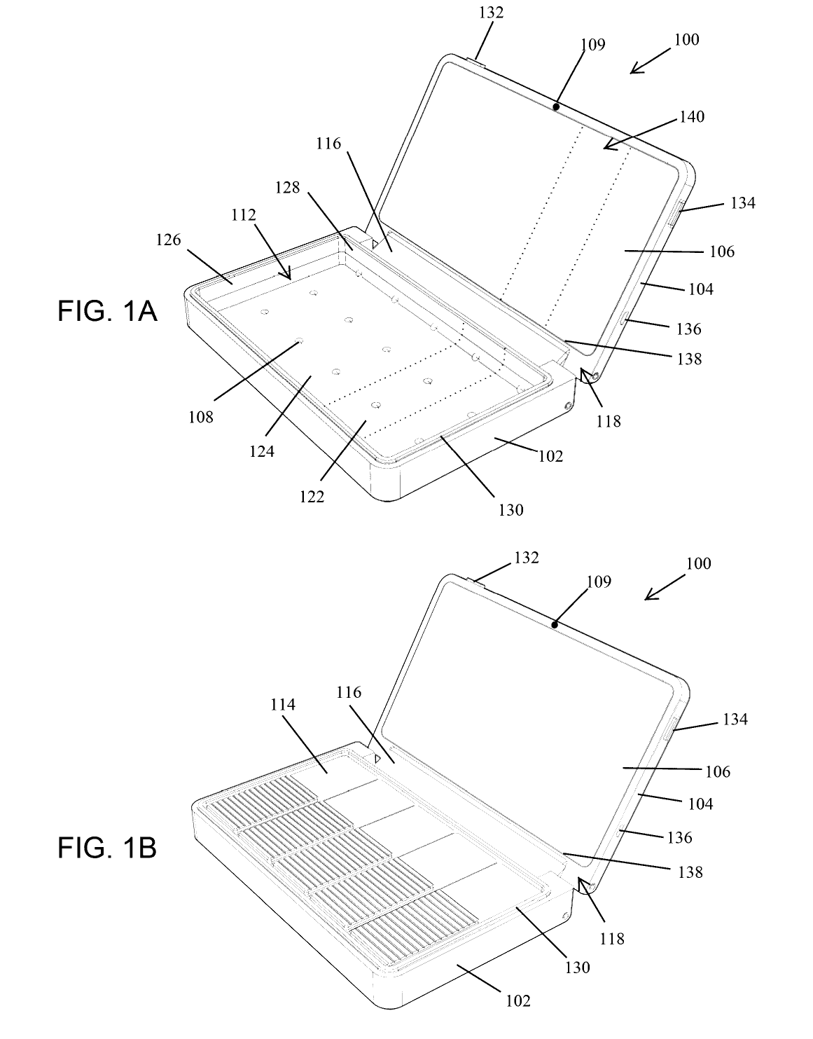

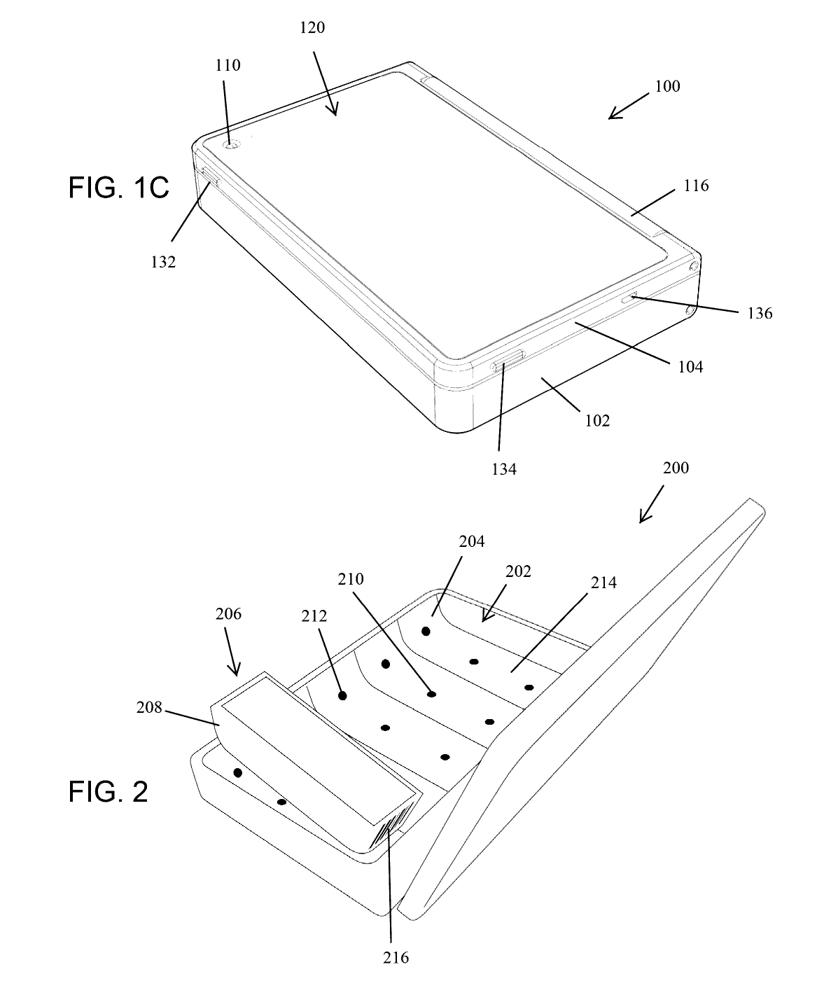

FIGS. 1A-1C show an electronic pillbox, according to one embodiment. The electronic pillbox 100 may include, among other components, a base 102, a lid 104, a visual display 106, and a sensor system. The sensor system may include one or more sensors or cameras 108, 109, 110. The base 102 may include one or more receptacles 112 that is configured to receive or interact with one or more pill containers 114. FIGS. 1A and 1B show the electronic pillbox 100 in an open state. In FIG. 1A, the receptacle 112 is empty, and in FIG. 1B, the receptacle is filled with pill containers 114. FIG. 1C shows the electronic pillbox 100 in a closed state. The base 102 and lid 104 may be movably attached in any suitable way, such as with a hinge mechanism 116, or a slide mechanism. The lid 104 may be moved between a closed position, shown in FIG. 1C, where the lid may cover the receptacle 112, and an open position, shown in FIGS. 1A and 1B, where the receptacle may be exposed. The lid 104 may include an internal surface 118 and an external surface 120, and the visual display 106 may be positioned on or integrated with the internal surface and/or external surface. While not shown, the electronic pillbox 100 may also include hardware and/or software that collectively form a control system, such as a processor, memory, and an input/output subsystem, and one or more communication modules configured to transfer and receive information between the electronic pillbox and other devices or systems.

### Base

A base of an electronic pillbox may include one or more receptacles to receive one or more pill containers. The electronic pillbox 100 shown in FIGS. 1A and 1B includes a base 102 with one receptacle 112 that is configured to receive or interact with more than one pill container 114, here five. The receptacle 112 may include one or more pill container regions 122, and each pill container region may be an area of the receptacle that is configured to receive at least one pill container. For example, the receptacle 112 shown in FIGS. 1A and 1B includes five pill container regions 122 (only one is shaded in FIG. 1A), and each pill container region is configured to receive one of the pill containers 114 shown in FIG. 1B. While the pill container regions 122 shown in FIG. 1A are continuous, pill container regions may be at least partially separated. Separation of pill container regions may facilitate proper placement of pill containers into different pill container regions and/or align pill containers with sensors or other features of the electronic pillbox.

It should be appreciated that an electronic pillbox may include any suitable number of receptacles and pill container regions, and that the number of pill containers that may be received by a receptacle or pill container region may depend on the configurations of the receptacle, pill container region, and/or pill containers. In some variations, a receptacle and/or a pill container region may be configured to receive one type (e.g., size, shape) of pill container, and in other variations the receptacle and/or the pill container region may be configured to receive multiple types of pill containers. The electronic pillbox may also include more than one receptacle and/or pill container region with different configurations.

The receptacle 112 shown in FIG. 1A is an open, recessed area of the base 102. The receptacle includes a bottom wall 124, two sidewalls 126, a posterior wall 128, and an anterior wall (not shown). The size and shape of the receptacle 112 (i.e., the dimensions and shapes of the receptacle walls) may be configured to receive one or more variations of pill containers. For example, in some variations, the width (i.e., distance between the sidewalls 126) and/or length (i.e., distance between the anterior wall and posterior wall 128) of the receptacle 112 may be approximately the same or a multiple of the width and/or length of a pill container, which may allow one or more pill containers to fit tightly into the receptacle. The depth or height of the receptacle 112 may be such that a top of a pill container stationed in the receptacle may be approximately at or below a top edge 130 of the receptacle, which may allow the lid 104 to close completely over the pill container.

While the cross-sectional shape of the receptacle 112 shown in FIG. 1A is substantially rectangular, the receptacle may have any suitable cross-sectional shape (e.g., circular, ellipsoid, triangular, irregularly shaped). The shape of at least a portion of the receptacle 112 may be configured to be complementary to at least a portion of a pill container, which may facilitate placement of a desired type of pill container in the receptacle and/or facilitate placement of a pill container in the receptacle with a desired orientation. The walls of the receptacle 112 shown in FIG. 1A are substantially flat, and the side and posterior walls 126, 128 are vertical with respect to the horizontal bottom wall 124 (i.e., the side and posterior walls are perpendicular to the bottom wall). However, one or more of the walls of the receptacle 112 may include one or more curves and/or join one or more other walls of the receptacle with any suitable angle. For example, FIG. 2 depicts a variation of an electronic pillbox 200 comprising a receptacle 202 with a curved anterior wall 204. As shown, the receptacle's curved anterior wall 204 may be complementary to a curved anterior wall 208 of a pill container 206. For example, the anterior wall 204 of the receptacle 202 may include a concave curve that matches, or has the same radius of curvature as an outer convex curve of the anterior wall 208 of the pill container 206.

While the receptacle shown in FIG. 1A is an open recessed space in the base, it should be appreciated that a receptacle may include any suitable form. For example, the receptacle may include a flat surface on the base, drawers within the base, one or more covered compartments, or the like. In some variations, the receptacle may have one or more features to facilitate positioning, docking, or stationing of a pill container in the receptacle in a desired location (e.g., within a pill container region) or with a specific orientation. For example, as mentioned, walls may partially or completely separate pill container regions, which may facilitate proper positioning of pill containers in the pill container regions. In some variations, the electronic pillbox may include one or more components that have one or more corresponding and complementary components on a pill container. For example, the electronic pillbox and/or the pill container may have male/female components, hooks, clips, latches, and/or the like that interact to facilitate proper positioning, stationing, or removable locking of the pill container in the receptacle. In some variations comprising a releasable locking system, the locking system may be configured to selectively releasably secure individual pill containers, or all of the pill containers at once. In still other embodiments, a releasable magnet system may be provided to facilitate releasable attachment of the pill container to the receptacle in the pill container region.

### Lid

An electronic pillbox may include a lid, which may be configured to reversibly cover one or more receptacles of the base and one or more pill containers stationed in the one or more receptacles. The lid may be removably or permanently attached to the base, and the lid may be movable relative to the base in order to open and close the pillbox (i.e., uncover and cover one or more receptacles). For example, the electronic pillbox 100 shown in FIGS. 1A-1C includes a lid 104 that is movably coupled to a base 102 with a hinge mechanism 116. As shown, the lid 104 may include an internal surface 118 and an external surface 120. When the lid 104 is in an open position, as shown in FIGS. 1A and 1B, both the internal and external surfaces 118, 120 may be exposed (e.g., may be accessible to a user). When the lid 104 is in the closed position, as shown in FIG. 1C, the external surface 120 may be exposed, but the internal surface 118 may be inaccessible to a user. The lid may have approximately the same or a different length and/or width as the base, and the length and the width of the lid may be at least great enough to cover at least a portion of one or more receptacles and/or pill container regions. In some variations, an electronic pillbox may include more than one lid, and each of the lids may cover at least a portion of different receptacles and/or pill container regions.

A lid and/or a base of an electronic pillbox may include one or more components to allow a user to control the electronic pillbox and/or to enable the electronic pillbox to communicate with other devices. For example, the electronic pillbox 100 shown in FIGS. 1A-1C includes two buttons 132, 134 and one port 136. However, the electronic pillbox may include any suitable number of input elements, including but not limited to buttons, switches, directional pads, joysticks, touch-sensitive areas (e.g., touchscreens, touchpads, fingerprint recognition areas), and/or ports (e.g., input ports, output ports). While the buttons 132, 134 and the port 136 are shown on the lid 104 in FIGS. 1A-1C, components such as these may be positioned on any suitable portion of the base 102 or lid 104. The input elements may be used to power the electronic pillbox and/or visual display on or off. As another example, a button or switch may be used to navigate to different screens of the visual display and/or select between options shown on the visual display. An input element may have a fixed function (e.g., an on/off switch) or a variable function (e.g., a soft key that has different functions depending on the screen shown on the visual display). In some variations, a switch, a button, or the like may control mechanical features of the electronic pillbox, such as unlocking or locking the lid and the base. One or more ports may be configured for any suitable input or output, such as USB (e.g., USB-A, USB-C, micro-USB and mini-USB), IEEE 1394, external monitor, audio, power, and the like.

An electronic pillbox may include one or more indicators that may communicate information to a user. For example, the electronic pillbox may include one or more optical or visual indicators, tactile indicators, and/or audio indicators. For example, the electronic pillbox may include one or more optical indicators that are located on a base or an internal or external surface of a lid. In some variations, the optical indicator may be a light that may turn on and off and/or change colors to communicate information. For example, an optical indicator may be turned on (i.e., illuminated) when the electronic pillbox is on and turned off when the electronic pillbox is off. As another example, an electronic pillbox may include one or more optical indicators associated with each receptacle, pill container region, and/or pill container stationed in a receptacle. These indicators may display different colors to communicate different information to a user, such as identifying a pill container that contains pills that should be taken at the current time, identifying a pill container that should be refilled, or indicating that a pill container is open or closed. In some variations, an optical and/or audio indicator may communicate one or more alerts or warnings, such as alerts indicating it is time for a user to take a medication, a pill container should be refilled, a pill container is not positioned properly in a receptacle, system errors, and the like. One or more tactile indicators, such as one or more areas with a different texture than a surrounding area, may be associated with one or more receptacles and/or pill container regions and may, for example, communicate information to a user such as a proper orientation for a pill container to be inserted into the electronic pillbox.

### Sensor System

An electronic pillbox may include a sensor system that may be configured to detect one or more characteristics of the environment surrounding the electronic pillbox. The sensor system may include one or more transducers or sensors and one or more sensor types. For example, a sensor system may include one or more optical or imaging sensors (e.g., camera elements, proximity sensors, motion sensors, infrared sensors, lensless smart sensors with or without built-in light, or the like), tactile sensors (e.g., force/weight sensors, pressure sensors, other touch-sensitive sensors, or the like), mechanical sensors, and/or any other suitable sensor type. Generally, a sensor may detect a signal or a change in the environment and produce an output, such as an electrical signal, that may be received by a control system of the electronic pillbox. The sensor system may be configured to detect a wide range of characteristics or signals which may indicate, for example, various states of the electronic pillbox and/or pill containers (e.g., open or closed), information about a specific medication (e.g., generic name and/or trade name, prescribed dose, dosage schedule, side effects, warnings, drug interactions), and/or actions that have been taken by a user (e.g., a pill has been removed from a pill container, a pill has been taken/ingested by a user). Sensors may be located in any suitable position on the electronic pillbox, and the position may allow the sensors to detect specific characteristics of the environment. For example, one or more sensors may be positioned in a receptacle in order to detect signals related to pill containers and/or pills.

In some variations, a sensor system may be configured to detect one or more positions or states of the electronic pillbox and/or one or more pill containers. For example, the sensor system may be configured to detect when the electronic pillbox is in an open state (i.e., the lid is in an open position) and/or when the electronic pillbox is in a closed state (i.e., the lid is in a closed state). As may be appreciated by one of skill in the art, this type of detection may be accomplished with multiple types of sensors in multiple ways, such as by detecting changes in a position of the lid, detecting contact between the lid and the base, and/or by detecting changes in light as the lid is open or closed. The sensor system may utilize one sensor type or multiple sensor types to detect the same state or position. In some variations, a sensor system may be configured to detect at least one of an open and closed state of a pill container, the presence and absence of a pill container in a receptacle, and/or a desired and undesired positioning of a pill container in a receptacle. When a pill container is stationed in a receptacle, the sensor system may be configured to detect the number of pills in the pill container.

In some variations, a sensor system may be configured to detect pill information from a pill container and/or from a pill. For example, the sensor system may detect one or more identifiers on a pill container and/or a pill. An identifier may be a unique symbol, code, or feature that may be specific to a certain pill or pill container. For example, the sensor system may be configured to detect identifiers on a pill container including, but not limited to barcodes (e.g., linear barcodes, two dimensional or matrix barcodes), identifying numbers (e.g., National Drug Codes), RFID tags, identifying text (e.g., standard identifying text on a pill container), and/or the like. Detection of an identifier on a pill container may enable the electronic pillbox to obtain information (e.g., generic name and/or trade name, prescribed dose, dosage schedule, side effects, warnings, drug interactions, etc.) about a pill contained in the pill container. Information may be obtained by the electronic pillbox directly from the identifier and/or indirectly from the identifier. For example, information obtained from the identifier may be used to obtain further information from the electronic pillbox's memory or from a remote server. The sensor system may additionally or alternatively be configured to detect one or more identifiers of a pill, such as an imprint on the pill (e.g., identifying symbol, alpha-numeric code), the size of the pill, the color of the pill, the shape of the pill, the type of pill (e.g., tablet, gel or liquid capsule, soft capsule, hard capsule, lozenge, oral disintegrating pill) and/or the like.

In some variations, a sensor system may be configured to detect one or more actions of a user. For example, the sensor system may be configured to detect when a user removes one or more pills from a pill container, such as by detecting insertion of a finger into the pill container and/or detecting movement of one or more pills out of a container, or any motion in a container. The sensor system may additionally or alternatively be configured to detect when a pill is taken (e.g., placed in a user's mouth, administered). It should be appreciated that any combination of the sensor types described herein may be configured to detect any of the states, signals, and/or actions described herein.

Sensors of a sensor system may be positioned at any suitable location on or in the electronic pillbox, and the locations may facilitate detection of certain signals or characteristics of the environment. For example, the sensor system may include one or more sensors mounted in or on a receptacle of the electronic pillbox, and these sensors may be configured to detect information related to one or more pill containers and/or pills that may be retained in the receptacle. For example, FIG. 1A shows an electronic pillbox 100 with a sensor system that includes a plurality of sensors 108 in or on the bottom wall 124 of the receptacle 112, according to one embodiment. While the sensors 108 in the receptacle 112 may have any suitable configuration, as shown, an array of sensors is mounted about each pill container region 122. With this configuration, the sensors 108, which may be optical sensors such as lensless smart sensors with built-in light and/or camera elements, may be configured to detect at least one of the presence or absence of a pill container in each pill container region 122, movement in a pill container, or the number of pills within a pill container that is stationed in the receptacle 112.

FIG. 2 shows an electronic pillbox 200 with a sensor system that also includes a plurality of sensors 210, 212 positioned in or on the receptacle 202, according to one embodiment. In this variation, certain sensors 210 are located in or on a bottom wall 214, other sensors 212 are located in or on an anterior wall 204, and still other sensors (not shown) are located in or on a posterior wall (not shown). The sensors 210, 212 with different locations may be configured to detect the same or different signals. For example, the pill container 206 shown in FIG. 2 includes a posteriorly-located identifier 216, and accordingly, one or more sensors located in the posterior wall (not shown) of the receptacle 202 may be configured to detect the identifier. As was discussed with respect to FIG. 1A, the sensors 210 located in the bottom wall 214 may be configured to detect one or more of the presence and/or absence of a pill container 206 in the receptacle 202, movement of pills in the pill container, and/or the number of pills in the pill container. The sensors 212 located in the anterior wall 204 may additionally or alternatively be configured to detect one or more signals corresponding to pill removal from the one or more pill containers 206.

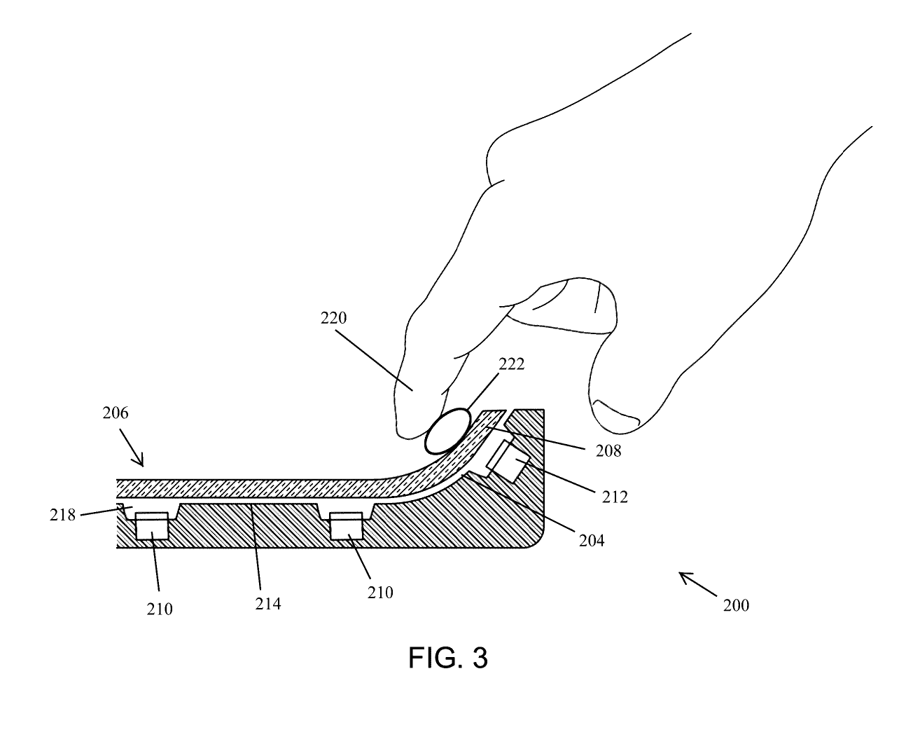

The sensors 210, 212 in the bottom wall 214 and anterior wall 204 of the receptacle 202 are depicted in more detail in FIG. 3, which is a cross-sectional view of a portion of the electronic pillbox 200 shown in FIG. 2. FIG. 3 also includes a portion of the pill container 206 shown in FIG. 2 stationed in a receptacle of the electronic pillbox 200. A finger 220 of a user is shown removing a pill 222 from the pill container 206 by sliding the pill along an anterior wall 208 of the pill container towards an open top. One or more sensors 212 located in the anterior wall 204 of the receptacle may detect one or more signals that may indicate that the pill 222 is being removed from the pill container 206. For example, one or more sensors 212 located in the anterior wall 204 of the receptacle may detect insertion of the finger 220 into the pill container 206 and/or movement of the pill 222 in a direction towards the open top of the pill container. FIG. 3 also illustrates that one or more sensors 210, 212 may be positioned in a recess 218 or shallow depression of a receptacle wall 214, 204. This configuration may allow the pill container 206 to be positioned adjacent to or in contact with one or more receptacle walls 214, 204 without contacting the sensors 210, 212, which may decrease the risk of damage to the sensors or interference with sensor detection.

In some variations, an electronic pillbox may have a sensor system comprising one or more sensors located on one or more surfaces of a lid of the electronic pillbox. For example, FIGS. 1A and 1B depict a camera element 109 positioned on an internal surface 118 of the lid 104, and FIG. 1C shows a camera element 110 positioned on an external surface 120 of the lid 104. Positioning one or more sensors on the internal surface of the lid may be advantageous for detecting movement and/or positions of a user's body, such as the user's hand and/or mouth. Positioning one or more sensors on the lid may be advantageous for other types of detection as well, such as detecting open and/or closed positions of the lid. A visual display may be positioned on the lid, and in some variations, the sensor system may include at least a portion of the visual display. For example, the visual display may be a touch-sensitive display system, or touchscreen, which may include one or more sensors that may accept input from a user based on haptic and/or tactile contact. In some variations, a camera, in conjunction with the user display, may be used for a visual communication with a doctor, caregiver, pharmaceutical consultant, insurance agent, etc.

As described in greater detail below, a camera may also be used to read a barcode of a regular pill container of OTC medication, CAM or prescription medication, or the text on a the container or packaging, to extract or retrieve the information of the medication.

### Visual Display

An electronic pillbox may include one or more visual displays or real-time updatable graphical user displays that may be configured to communicate useful information to a user and, in some variations, allow a user to provide input. The visual display may receive information from the control system, and communicate this information to a user via visual output in the form of graphics, text, icons, video, or any combination thereof. The visual output may communicate one or more types of information related to a pill (e.g., generic name and/or trade name, prescribed dose, dosage schedule, side effects, warnings, drug interactions, etc.), a pill container (e.g., remaining number of pills, open or closed state), medication compliance (e.g., compliance history), user actions (e.g., alerts to prompt a user to take a medication, consult a health care professional), and/or the electronic pillbox (e.g., low battery, system errors). A visual display may use LCD (liquid crystal display) technology, LPD (light emitting polymer display) technology, LED (light emitting diode) technology, and/or any other display technology.

In some variations, an electronic pillbox may include one or more visual displays that may be touch-sensitive display systems, or touchscreens. The touchscreen may include one or more sensors that may accept input from a user based on haptic and/or tactile contact. For example, the touchscreen may detect user contact using any suitable object or appendage, such as a stylus, a finger, or the like. The touchscreen may detect contact and/or movement using any of a plurality of touch sensing technologies, including but not limited to capacitive, resistive, infrared, and surface acoustic wave technologies, as well as other proximity sensor arrays or other elements for determining one or more points of contact with the touchscreen. In some variations, in addition to or as an alternative to a touchscreen, the electronic pillbox may include one or more soft keys, or physical buttons associated with the visual display. These soft keys, which may be adjacent to the visual display, may be used to select or input different information depending on the visual output provided.

One or more visual displays may be located on any suitable portion of an electronic pillbox, such as an internal and/or an external surface of a lid. For example, the variation of an electronic pillbox 100 shown in FIGS. 1A and 1B includes a visual display 106 located on an internal surface 118 of a lid 104. The visual display 106 may be any suitable size, but in some variations, the size may be configured to facilitate the communication of information related to individual pill containers 114 and/or pill container regions 122. For example, the visual display 106 may include a first edge 138 with a length that spans across at least a portion of each of the pill container regions 122. In some variations, the first edge length may be approximately the same as the length of the receptacle 112 (i.e., the distance between the sidewalls 126). In this way, information may be shown on the visual display 106 that corresponds to and/or aligns with one or more pill container regions 122. For example, the visual display 106 may be configured to show one or more screens that are divided into different areas, and each area may correspond to, or align with, a different pill container region 122. For example, one or more screens of the visual display 106 may be divided into columns 140 (only one column is shown shaded in FIG. 1A), and each column may display information specific to a corresponding pill container region 122, a pill container 114, or the internal content therein. As shown in FIG. 1A, the shaded column 140 of the visual display 106 is above and in-line with its corresponding, shaded pill container region 122, and this alignment may facilitate a user's ability to identify the pill container region that information on the display is referring to. In other embodiments, a plurality of separate or distinct displays may be provided, some or all of which are associated with a pill container region.

While the visual display is generally described here as being positioned on the electronic pillbox, it should be appreciated that in some variations, a visual display may additionally or alternatively be an external device. For example, an external monitor may be connected by wire or wirelessly, to an electronic pillbox, and the external monitor may be configured to display information to the user. The information displayed may mirror the information provided on the internal display, or may be different or complementary. In other variations, the electronic pillbox may include both an internal visual display and an external visual display, on the lid and/or base.

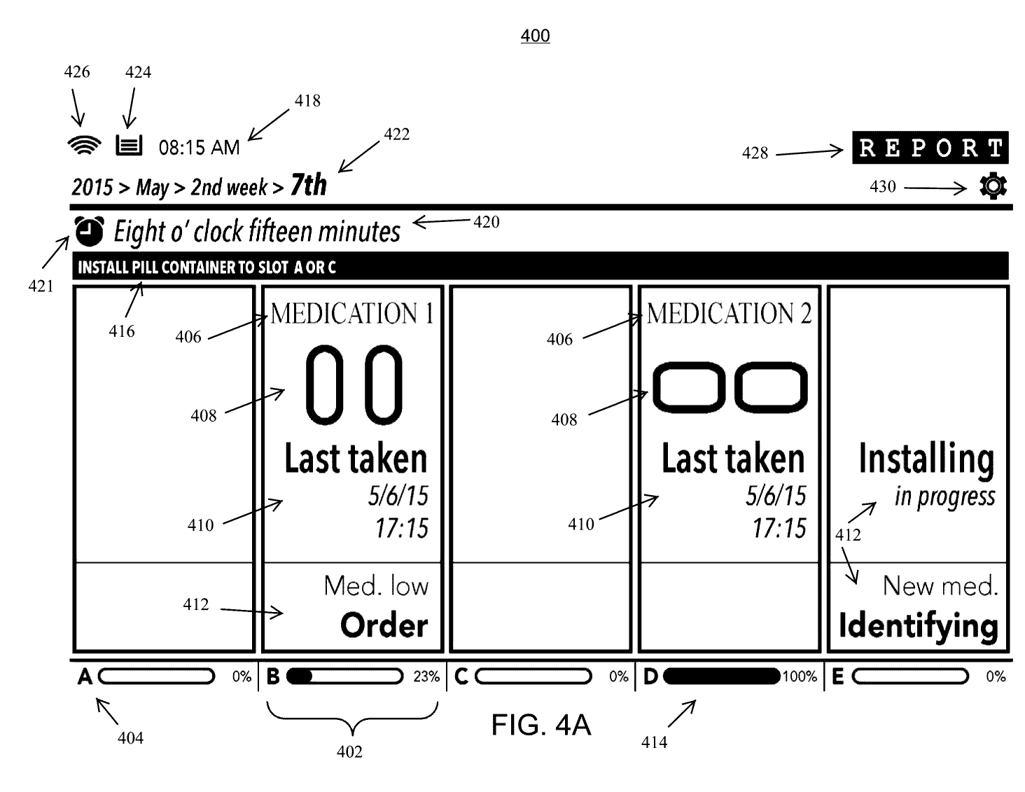

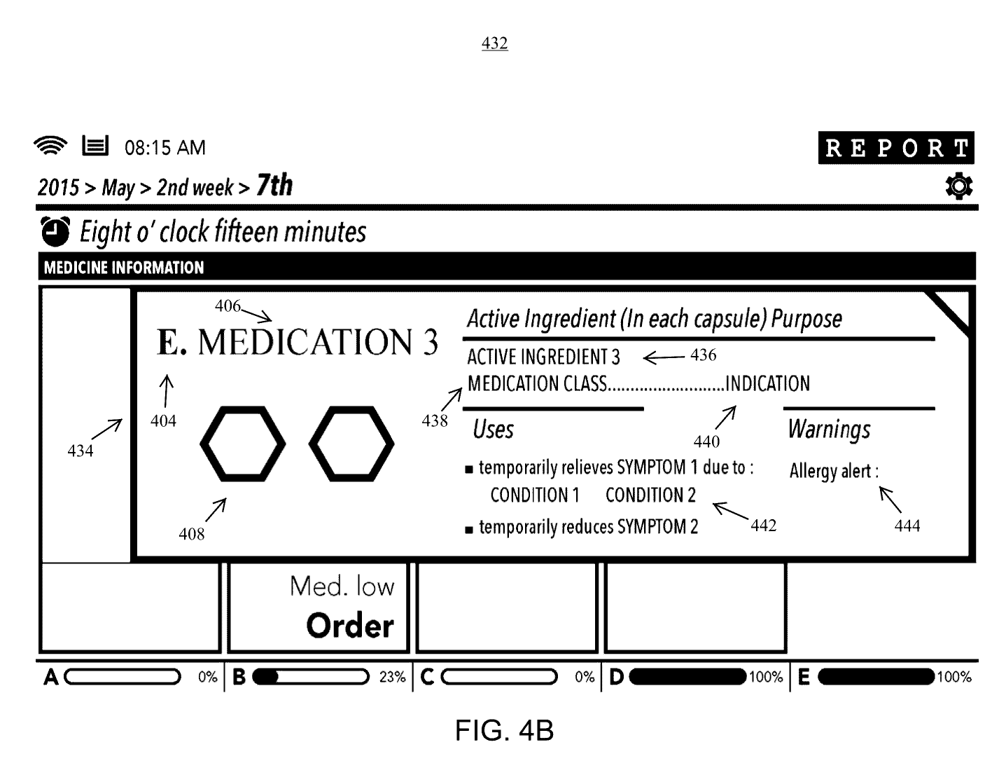

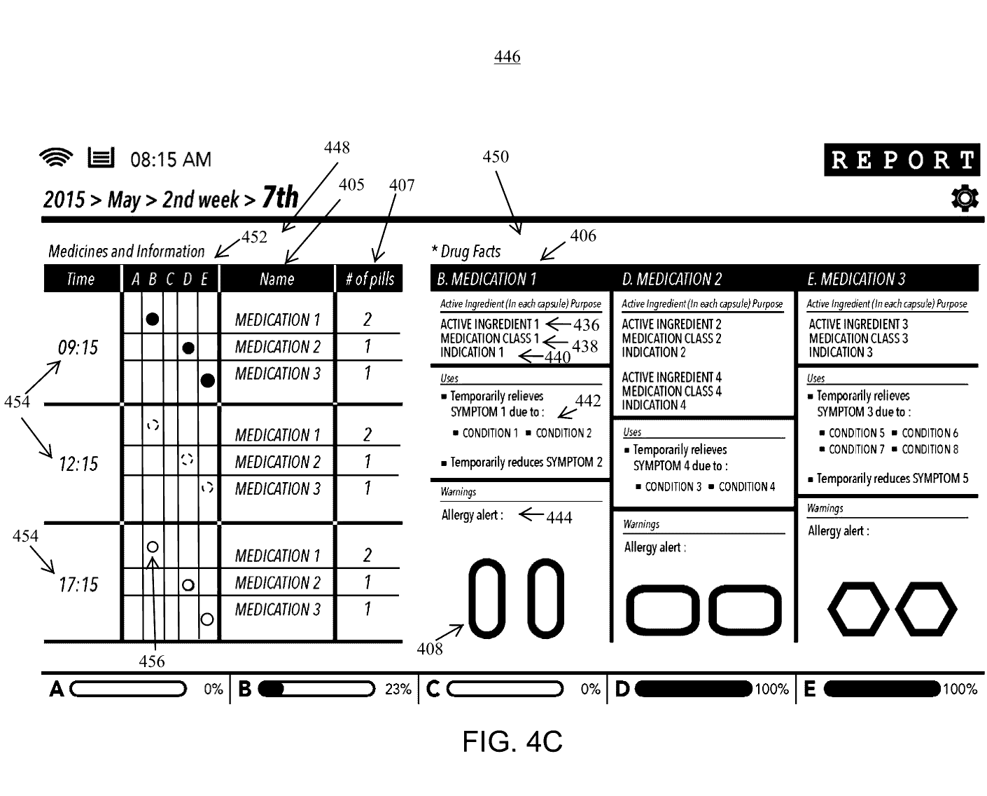

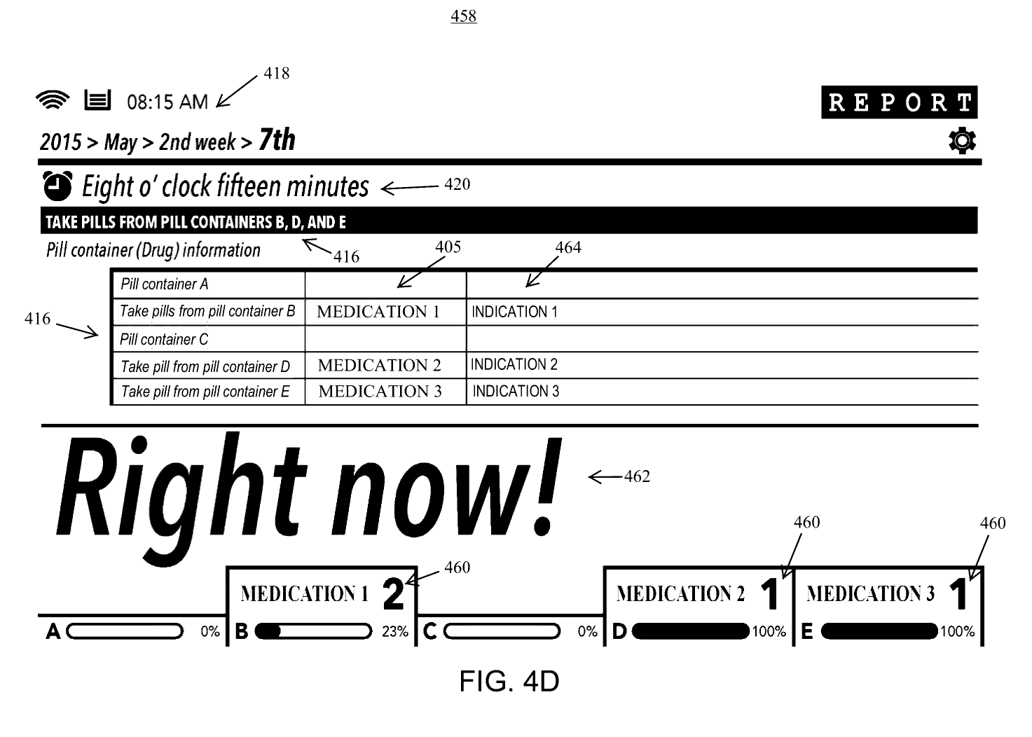

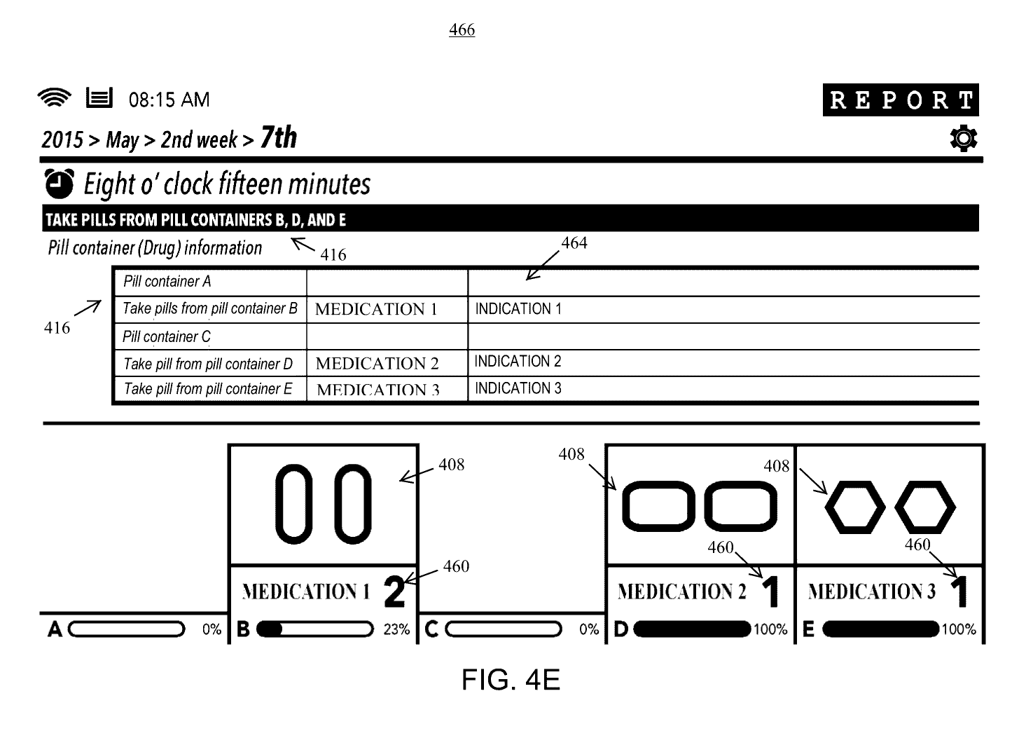

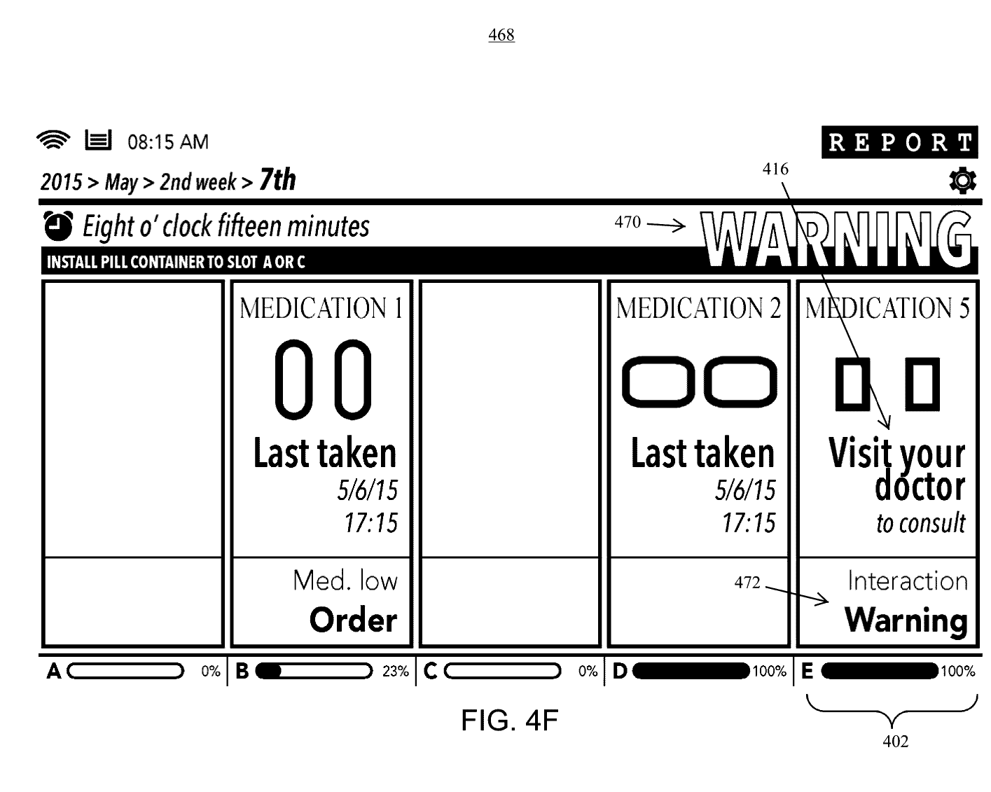

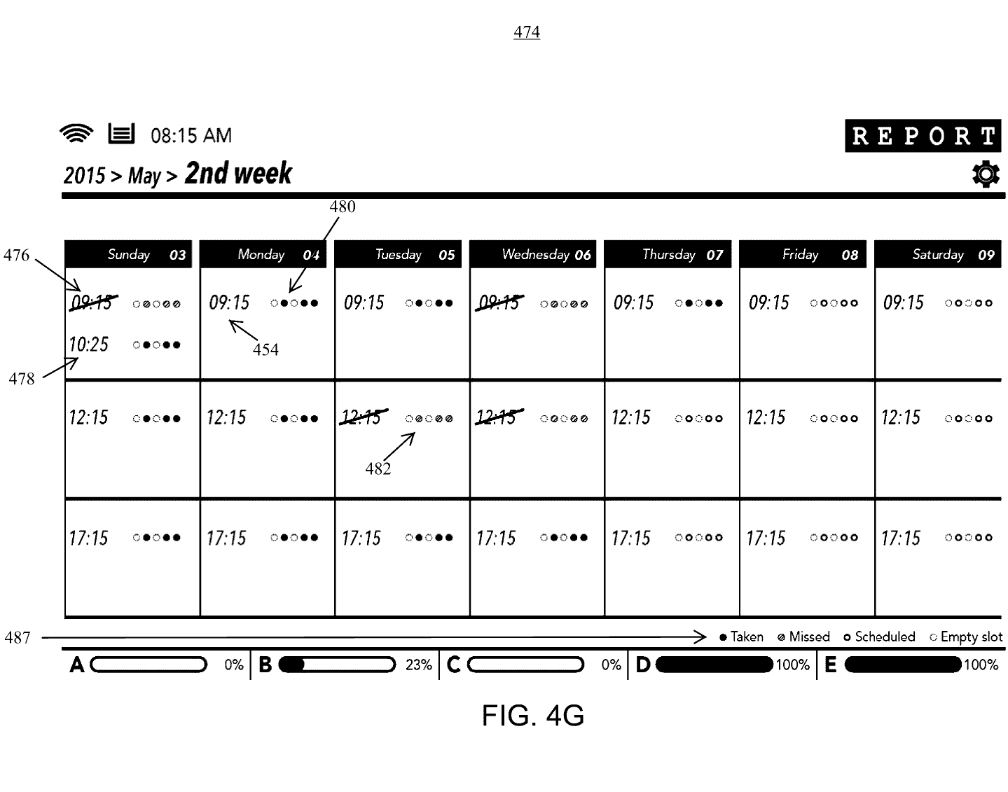

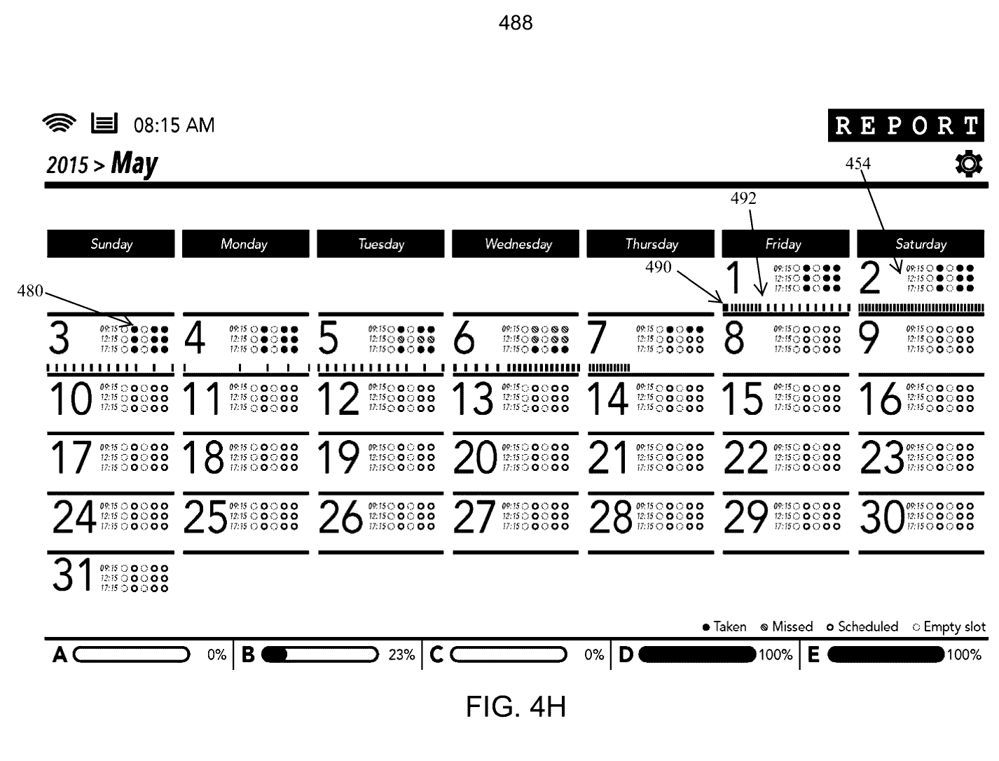

Examples of the type of information that may be communicated to a user via a visual display will be described by way of multiple representative screens that may appear on the visual display. It should be appreciated that any combination of the features described and/or illustrated in the figures may be incorporated into a visual display. FIGS. 4A-4I are representative screens that may appear on a visual display of an electronic pillbox variation that includes five pill container regions. Throughout the description of the screens, each pill container region may be labeled and referred to as a “slot” and each of the slots may be labeled and referred to with a letter (i.e., slot A, slot B, slot C, slot D, slot E). While the screens shown in FIGS. 4A-4I are configured for use with an electronic pillbox comprising five pill container regions, analogous screens may be configured for use with any of the electronic pillbox variations described here.

FIG. 4A depicts a representative screen 400 that may appear on a visual display of an electronic pillbox, according to one embodiment. Several types of information are shown on the screen 400, including information related to each pill container region, or slot, of the electronic pillbox. Information related to each slot may be organized into different areas of the screen 400, which may improve a user's ability to identify the slot that certain information is referring to. As shown, the screen 400 may include separate columns 402 that each corresponds to a different slot, and each column may be aligned with its corresponding slot (e.g., the position of a column relative to the screen, visual display, or lid may be approximately the same as the position of a corresponding slot relative to the receptacle or base.) Additionally or alternatively, each column 402 may include a label 404, in this case a letter, to indicate the slot that it corresponds to. In some variations, the same label may also be positioned on or near the corresponding slot. Although the exemplary columns 402 depicted in FIG. 4A span the bottom to the top of the screen 400, in other examples, the columns may span only a partial height, e.g., from the bottom to about half the height of the screen, or a higher or lower height. In other variations, the shape of the region may be square or oval, or some other shape.

Each column 402 may include one or more types of information related to its corresponding slot, and this information may be organized into separate areas within each column. The type of information displayed in the column 402 may be different for different states of the corresponding slot or states of a pill container that is stationed in the corresponding slot (e.g., absence of a pill container in the slot, presence of a pill container in the slot, pill container recently stationed in the slot, pill container in the slot with a certain amount of remaining pills, unrecognized container in the slot). For example, as shown in FIG. 4A, the columns 402 with labels 404 “B” and “D” (“columns B and D”) may correspond to slots with stationed pill containers that have been identified by the electronic pillbox, column E may correspond to a slot with a stationed pill container that is being identified by the electronic pillbox, and columns A and C may correspond to slots without stationed pill containers.

Each column 402 may display information related to a pill container that is currently, has been, or will be stationed in a corresponding slot. For example, the column 402 may display a medication name 406 and one or more pill pictures 408 of a pill that is or was within a pill container positioned in the corresponding slot. Column B indicates that the medication name 406 of the pill contained within the pill container stationed in slot B is “Medication 1.” Similarly, column D indicates that the medication name 406 of the pill contained within the pill container stationed in slot D is “Medication 2.” The one or more pill pictures 408 may include illustrations of the pill, images or photographs of the pill, color, black and white, multiple views, the actual pill size, identifying pill symbols, letters, numbers, and/or the like.

A column that corresponds to a slot with a stationed pill container may display information related to the compliance, administration history, and/or the status of the pill container and/or pills within the pill container. For example, columns B and D show an administration history 410 that includes the most recent date and time when a pill from the corresponding pill container was taken by a user. Columns B and D also display information related to the status of the pill container in the corresponding slots. For example, column B has a status alert 412, which may notify a user of useful information related to the pill container in the corresponding slot. For example, the status alert 412 in column B notifies a user that the medication in the pill container stationed in the corresponding slot is low and that a new or refilled pill container should be ordered. Such a status alert 412 may appear when the electronic pillbox determines that the number of pills and/or doses remaining in a pill container has decreased below a specific threshold. Other status alerts 412 related to the pill container and/or pills within the pill container may be displayed, such as, but not limited to the status alerts shown in column E. The status alerts 412 shown in column E may notify a user that a pill container is being installed (i.e., the electronic pillbox is determining information about the pill container and/or the pills within the pill container) and that a medication in the pill container is being identified.

One or more columns 402 of an electronic pillbox visual display screen may include a pill count or level indicator 414. The pill level indicator 414 may communicate to a user the pill level, or amount of medication (e.g., number of pills, number of doses, percentage of pills, percentage of doses) that remains in a pill container stationed in a corresponding slot. The pill level indicator 414 may include graphics, symbols, numbers, and/or text to indicate the pill level. For example, the pill level indicators 414 shown in FIG. 4A include a numerical percentage of remaining pills (i.e. the percentage of pills originally in the pill container that remain in the pill container) and a bar with shaded and unshaded regions. The percentage of the bar that is shaded is approximately the same as the percentage of pills or doses that remain in a corresponding pill container. In other variations, haptic feedback or a sound response may also be provided as an indicator of pill level or count, in lieu of or in addition to the visual display.

FIG. 4A illustrates other information that may be communicated to a user via a visual display and options that the user may select, according to one embodiment. For example, the screen includes an instruction section 416 that may prompt a user to perform an action related to the electronic pillbox, a pill container, a slot, or a pill. As shown, the instruction section 416 prompts a user to “install pill container to slot A or C.” This instruction is consistent with the lack of any pill or pill container information displayed in columns A or C, which may indicate that the corresponding slots A and C are empty. The screen 400 may display information related to the time and date in one or more locations on the screen. For example, the screen 400 includes a first time area 418, a second time area 420, and a date area 422. In some variations, the first time area 418 may be the local time or other user selected time, while the second time area 420 may indicate a future time representative of an alarm time or pill taking time, and may include other indicia or symbols, such as a pill or alarm symbol 421, to indicate the nature of the indicator time. While the time is shown displayed numerically in the first time area 418 and with text in the second time area 420, the time may be displayed in any form (e.g., numerical, graphically, text, 24hr, and the like). Similarly, the date area 422 may display the date in any format (e.g., numerical, text, graphically). In some variations, the date area 422 and/or at least one of the first or second time areas 418, 420 may be displayed on multiple screens of the visual display. In some variations, the date area 422 may be user selectable between the day, week, month and year views of the calendar.

A screen of the visual display may show status information related to the electronic pillbox. For example, screen 400 includes a battery level indicator 424 which may show the amount of battery life using graphics, numbers, and/or text. Screen 400 also includes a network connection indicator 426, which may indicate if the electronic pillbox is connected to a network (e.g., the Internet, an intranet, a wireless network) and, in some variations, the strength of the connection. The screen 400 illustrates that at least some screens, and in some variations all screens of the visual display may include a selectable report icon 428 and a selectable settings icon 430. Selecting the report icon 428 may allow a user to report summary information to a third party or other device, related to the use of the electronic pillbox or to a medication. In some variations, selecting the report icon 428 may provide a user with a report that includes information such as medication adherence or compliance, a medication list, allergies, past medical history, family history, or any other personal health related information. Information relating to medication adherence may include, for example, the compliance percentage over a period of time or a regimen, or may provide a correlation between compliance or medication intake and other health outcomes entered into the system. The information may be text, graphics, sounds, or combinations thereof In other variations, the report button or icon 428 may be used to ask questions or report issues relating to a medication, e.g., a drug reaction or other symptoms relating to the medication (e.g., glucose level, pain level or breathing rate), or initiate a voice or video call with a third person. Selecting the setting icon 430 may, for example, allow a user to change various settings related to the electronic pillbox (e.g., display settings, connection settings, audio settings, security settings). Additionally or alternatively, selecting the setting icon 430 may, for example, allow a user to view and/or modify account and/or other types of information related to health insurance, Apple HealthKit, a healthcare facility, and/or a pharmacy.

FIG. 4B is a representative screen 432 of an electronic pillbox visual display that shows detailed information about one of the medications in a pill container that may be stationed in a slot, according to one embodiment. The screen 432 may appear on the visual display, for example, when a new pill container has been inserted and recognized by the electronic pillbox and/or when a user makes a selection to view detailed pill information. As shown, detailed medication information is provided in a medication detail window 434. The medication detail window 434 includes a label 404, which, as discussed previously, may indicate the corresponding slot where the pill container containing the described medication is stationed. As shown, the medication detail window 434 provides information related to a medication that is in a pill container stationed in slot E. The medication described in the medication detail window 434 may be identified by a medication name 406 and one or more pill pictures 408, as was discussed with respect to FIG. 4A. The medication detail window 434 also includes the medication active ingredient 436, the medication class 438, the indication 440, uses 442, and medication warnings 444, such as an allergy alert. However, a medication detail window 434 may include any combination of information disclosed herein related to a medication, and this information may be displayed with any suitable layout.

FIG. 4C is a representative screen 446 of an electronic pillbox visual display that shows a medication regimen for one day, according to one embodiment. The screen 446 includes a daily dosage schedule 448 and a detailed multi-medication information window 450. The dosage schedule 448 includes medication names 405, medication slot indicators 452, scheduled medication administration/alarm times 454, and the pill number per dose 407. As shown, the slot indicators 452 contain circles 456 or other shapes, optionally with different colors or shading patterns, to indicate which slots the pills should be taken from for the specified administration time. Although the screen 446 includes a separate column 407 that indicates the number of pills to be taken from each slot at each scheduled administration time 454, in other variations, the number of pills may be indicated by the number of dots in each slot for the particular time 454. Also, while pill number per dose 407 is indicated numerically on screen 446, this number may be indicated with text, or the amount of medication per dose may be represented with a medication volume, weight, concentration, or the like. As shown, the dosage schedule 448 may indicate that at each scheduled administration time 454, two pills of Medication 1 should be taken three times a day, one pill of Medication 2 should be taken twice a day, and one pill of Medication 3 should be taken once a day, corresponding to slots B, D and E, respectively. In this particular example, slots A and C are empty. The shading or color of the circles 456 may indicate compliance information. In the particular example depicted in FIG. 4C, the closed, filled circles indicate dosages that were taken, shaded circles indicate dosages that were missed, and solid open circles indicate future scheduled dosages for that day, and half-filled dots are doses that were taken on a delayed basis. In other variations, as shown in FIG. 4G, doses taken on a delayed basis may also be shown as missed doses, but with a new time for the delayed administration. Empty slots may depicted as blanks, as in FIG. 4C, or dashed open circles, as in FIG. 4G. The time window or cut off for a dose taken on time, dose taken on delayed basis, and/or missed dose may be configurable from the user setting, or remotely by a third party. The scheduled administration times 454 may indicate the times of day when at least one of the medications in the electronic pillbox is scheduled to be taken. As shown, Medications 1-3 are scheduled to be taken together at three different times. Although scheduled administration times 454 in hours and minutes are depicted, the scheduled administration time may also be set relative to certain meals (e.g., pre- and post-prandial times) or bedtime, for example, and may include symbols corresponding to the different types of meals or bedtime (e.g., a fried egg for breakfast, sandwich for lunch, steak for dinner, and a pillow for bedtime), as well as optional “before” and “after” modifiers if the medication is to be taken before or after a meal, rather than during. Other symbols, including a stomach symbol and a food symbol, may be used to indicate taking a pill on an empty stomach or taking the pill with food.

In the particular example depicted in FIG. 4C, the indicators 456 are aligned to the associated medication 405 and pills per dose 407 columns, but in other examples, the slot indicators 456 may be aligned with the scheduled time 454, or as shown in FIG. 4G,with the scheduled administration time and each other.

The detailed multi-medication information window 450 shown in FIG. 4C includes information about each of the medications that are listed in the daily dosage schedule 448. The information listed for each medication may include, but is not limited to, the medication name 406, one or more pill pictures 408, the active ingredient/generic name and/or trade name 436, a medication class 438, an indication for the medication 440, uses 442, and/or warnings 444. The warnings 444 may include side effects, black box warnings and drug interactions. Patient specific information, such as dosage and dosage schedule, may also be provided in text form or traditional prescription language in the detailed multi-medication information window 450, which may be similar or different from the information presented in the daily dosage schedule 448.

FIG. 4D is a representative screen 458 of a visual display of an electronic pillbox that shows a user alert or alarm, which may correspond to a scheduled medication administration time, or other scheduled event, e.g., glucose testing, lab visit, treatment or diagnostic visit, etc. In some variations, screen 458 may be the initial screen shown on the visual display when the lid is opened and/or the electronic pillbox is powered up. The screen 458 may include one or more instruction sections 416 that instruct a user to take one or more pills. Presenting the same scheduled administration instructions in more than one location on a screen may be advantageous, such as by increasing the chances that a user sees and follows the instructions. Each medication that is due to be taken has an associated pill counter 460 that indicates the number of pills of each medication that are due to be taken. In the particular example in FIG. 4D, screen 458 indicates that the current time 418 is the alarm time 420, and that the patient is scheduled to take three medications at this time, with two pills of medication 1 from container B, one pill of medication 2 from container D, and one pill of medication 3 from container E. In addition, there may be one or more time alerts 462 that indicate when the pills are due to be taken, here “Right now.” Escalating alerts and alarms may be provided while this screen 458 is displayed. These alerts and alarms may include increasing frequency, intensity and/or duration of audible and/or haptic alerts, and/or visual alerts either from the visual display or from other light indicators mounted on the external surface of the system. The screen 458 also includes a brief multi-medication information window 464. As shown, the brief multi-medication information window 464 may include less medication information than the detailed multi-medication information window discussed with respect to FIG. 4C.

FIG. 4E is a representative screen 466 of a visual display of an electronic pillbox that instructs a user to take medication, according to one embodiment. This screen 466 may appear when it is time to take a medication, and in some variations after an alarm, such as the alarm discussed with respect to FIG. 4D, has been stopped. In some variations, the alarm may be stopped after at least one pill has been removed from the system, or a lid for a specific pill container has been opened. The screen 466 includes one or more instruction sections 416 that prompt a user to take pills, pill counters 460 to indicate the number of pills of each medication that should be taken, and a brief multi-medication information window 464. In contrast to the alarm screen shown in FIG. 4D, this screen 466 includes one or more pill diagram or pictures 408 of the pills or pill shape that should be taken to increase the likelihood that a user takes the medication as instructed, or to facilitate confirmation for the user that the correct pill was removed.

FIG. 4F is a representative screen 468 of a visual display of an electronic pillbox that provides a warning to a user, according to one embodiment. The screen 468 may include a general warning 470 and/or a specific warning 472. The general warning 470 may appear on a screen with any type of warning, whereas the specific warning 472 may indicate the type of, or reason for the warning, including but not limited to a drug interaction warning or a compliance warning. The specific warning 472 may be located in a region or column 402, which may indicate that the warning is related to the corresponding slot or the pills or pill container in the corresponding slot. For example, as shown on the screen 468, the specific warning 472 in column E may indicate that a medication in corresponding slot E may interact with at least one of the other medications in the electronic pillbox. In another example, a specific warning may be provided if the system detects that a pill has been removed that should not have been removed for the current administration time, or has already been removed for the current administration time. In some examples, in addition to non-compliance metrics related to failure to take a schedule dosage, the system may be configured to monitor for other erroneous medication intake, which may be useful for assessing basic daily functional activities or mental capacity. The screen 468 includes an instruction section 416, which may instruct a user how to respond to the warning, in this case by visiting a doctor or other healthcare provider or caretaker to consult. Specific administration information, such as taking the medication with food, or on an empty stomach, may also be provided here.

In some variations, one or more screens of a visual display may show a user's medication compliance over various time frames. For example, FIG. 4G is a representative screen 474 of a visual display of an electronic pillbox that shows a medication administration history or compliance for a week period. The screen 474 shows the scheduled administration times 454 when one or more medications were due to be taken. A missed administration time 476 may be depicted with a strikethrough line or other indicator (text, graphic or color), indicating that medication was not taken at the proper time, and an adjusted or delayed administration time 478 shows when the medication was actually taken. Compliance information may be provided by an administration tracker 480, and each scheduled administration time 454, missed administration time 476, and/or delayed administration time 478 may have an associated administration tracker. Thus, in addition to dose specific tracking indicators as shown in FIG. 4C date or time specific indicators may also be provided. For example, each administration tracker 480 shown in FIG. 4G may indicate the compliance on a certain date and at a particular time. The administration tracker 480 may have various graphical, textual, or numerical forms to illustrate medication compliance. For example, screen 474 has administration trackers 480 with circles that may have different colors or patterns to indicate different compliance information, as was discussed with respect to FIG. 4C. In the example shown in FIG. 4G, a filled circle 482 indicates a dose taken, a shaded circle 484 indicates a dose missed, a solid open circle 486 indicates a scheduled dose to be taken in the future, and a dashed circle indicates that no medication is scheduled to be taken. A key or legend 487 is provided on the screen 474 to communicate to a user the significance of each circle pattern. The circles may be organized such that the position of each circle in the administration tracker 480 may correspond to a different slot. For example, on the screen 474, the order of each circle in a row indicates which slot the circle refers to (e.g., the first circle in a row corresponds to slot A, the second circle in a row corresponds to slot B, etc.). In this way, the administration tracker 480 may indicate what medication was missed and at what time.

FIG. 4H is a representative screen 488 of a visual display of an electronic pillbox that shows compliance information for a month. For each day of the month, the scheduled administration times 454 are listed, and each scheduled administration time has an associated administration tracker 480. As shown, the administration trackers 480 have the same configuration as the administration trackers discussed with respect to FIG. 4G, and they may indicate the medication compliance at each scheduled administration time 454. In addition, compliance information may be shown graphically, such as with a compliance plot 490 or chart. In some variations, the closer the compliance plot 490 is to a continuous line (i.e., the less space there is between bars 492 of the compliance plot) the better the compliance for that day. In some variations, the compliance plot 490 may represent of an aggregate of medication compliance on the associated date over a specified amount of time (e.g., 3 months, 6 months, 1 year, more than 1 year). FIG. 4I is a representative screen 494 of a visual display of an electronic pillbox that shows compliance information for a year. This screen 494 has a compliance plot 490 that indicates medication compliance in each month. As with FIG. 4H, the less space there is between bars 492 of the compliance plot 490, the better the medication compliance for the associated time period.

In some variations, a screen that displays medication compliance information may also display information related to one or more other health status indicators (e.g., blood glucose, blood pressure, weight, symptoms such as pain, nausea, urinary frequency, etc. and/or the like), and this information may be displayed graphically (e.g., in a form similar to the compliance plots 490 shown in FIGS. 4H and 4I), numerically, and/or textually. Displaying information related to medication compliance and one or more health status indicators together may be advantageous as this may demonstrate a correlation between medication usage and health status, which may provide information related to the clinical effectiveness of a prescribed dosage regimen. As will be described in more detail herein, an electronic pillbox may be configured to communicate with one or more remote devices or servers, which may allow the electronic pillbox to obtain information related to one or more health status indicators from a health tracking or other medical device (e.g., glucometer, blood pressure cuff, phone or computer health applications, or the like).

While not shown, the visual display may include one or more screens configured for user input, such as with a virtual keyboard on the touchscreen. For example, one or more screens may allow or require a user to accept or decline information that was determined by the sensor system. For example, after the sensor system identifies a pill container based on an identifier, the user may accept, decline, and/or modify the information identified by the sensor system. The visual display may include screens which may allow a user to enter other health information, such as allergies, past medical history, family history, and the like. This information may be stored by the electronic pillbox and may be used, for example, to alert a user if the user is allergic to a pill that is within a pill container stationed in the receptacle. As will be described herein, the electronic pillbox may be configured to connect to a network (e.g., the Internet, an intranet, a wireless network) and communicate with one or more devices or servers over the network. The communication module may be used to retrieve or receive initial or updated health information from a remote server or other device (e.g., a health tracking device, a portable health device) without inputting the information manually. Similarly, information input into the electronic pillbox by the user may be stored in memory of a remote device and/or in storage of a remote server (e.g., cloud-based storage). Other user input screens may include communication screens, such as those that may allow a user to send and receive emails or other messages. In some variations, an electronic pillbox may be configured to allow a user to exchange messages with a healthcare professional or pharmacist. In some variations, the information that is provided by or received by the electronic pillbox via a remote server or separate device may be user customized to identify portions of the health record that may be shared (e.g., compliance information, past medical history, insurance information, emergency contact information, etc.) as described in greater detail below.

### Control System and Communication Module

An electronic pillbox may include a control system that may include hardware and software configured to receive input signals from one or more sources and provide output signals to one or more locations. For example, the control system may be configured to receive input from a sensor system and/or from user input sources (e.g., a virtual keyboard, a physical keyboard, a microphone for voice input). The control system may be configured to provide output to a visual display. The control system may also be configured to receive input from and/or provide output to a communication module, which may in turn exchange information with external and/or remote devices, such as remote servers, mobile phones, and computers. The control system may obtain input from the communication module such as medication information stored in remote memory or instructions provided by a healthcare provider. The control system may provide output to the communication module, which may in turn deliver output information such as compliance data or the number of remaining pills in a pill container to a healthcare provider, insurance provider, caretaker, user's family, pharmacy, and/or the like. In some variations, information from an electronic pillbox may be shared with certain permission (e.g., read-only, read & write) and a user may or may not be able to choose the type of permission for different shared files or information.

A control system may include, for example, one or more processing units (CPU's), memory, and an input/output subsystem. Memory may include high-speed random access memory, such as DRAM, SRAM, DDR RAM or other random access solid state memory devices and/or non-volatile memory, such as one or more magnetic disk storage devices, optical disk storage devices, flash memory devices, or other non-volatile solid state storage devices. The control system may include an operating system (e.g., Darwin, RTXC, LINUX, UNIX, OS X, WINDOWS, an embedded operating system such as VxWorks, Android, Firefox, or the like), which may include various software components and/or drivers for controlling and managing general system tasks (e.g., memory management, power management) and may facilitate communication between various hardware and software components. The input/output subsystem may allow the control system to communicate with the sensors, display and various communication modules, e.g., USB (e.g., USB-A, USB-C, micro-USB and mini-USB), Bluetooth, NFC, 802.11xx, GSM, CDMA, OFDM, etc.

The electronic pillbox may include one or more communication modules configured to communicate with one or more remote or external devices, such as a remote server, remote memory, a mobile phone, or a computer. The communication module may be capable of sending information and receiving information, and this communication may be through wired or wireless connections. For example, one or more communication modules may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol.

The system may also be configured to send an email or text message to a cell phone or computer of the user, family member, pharmacist, physician, nurse or other caretaker or healthcare worker. In some further variations, the system may be configured with multiple levels of reminders, and may be configured to escalate reminders to a third party when continued non-compliance is identified.

### Pill Containers

A sensor-based medication system may include one or more pill containers configured to reside in a receptacle of an electronic pillbox. A pill container may have multiple different forms including, but not limited to pill cartridges, pill bottles, blister packs, pill bags, or any other suitable rigid and/or flexible structure that may at least temporarily hold or contain one or more pills. A pill container may be configured to hold any suitable number of pills, and the pills may include one type of pill or more than one type of pill (e.g., one type of medication and/or one dose of a medication). For example, a pill container may be configured to hold a cocktail of pills, such as multiple types of pills that may be taken on the same schedule and/or for the same indication. A pill container may be configured to hold a prescription medication, an over-the-counter medication, and/or a complementary and alternative medicine product.

While the pill containers are generally described as holding medication in pill form, it should be appreciated that in some variations, the sensor-based medication system may include one or more medication containers configured to hold one or more medications in non-pill form. For example, the one or more medication containers may hold one or more medications in liquid, inhaled, or injectable form. In these variations, an administration tool, such as a cup for a liquid form, an inhaler for an inhaled form, or a syringe for an injectable form may or may not be held or stored in an electronic pillbox.

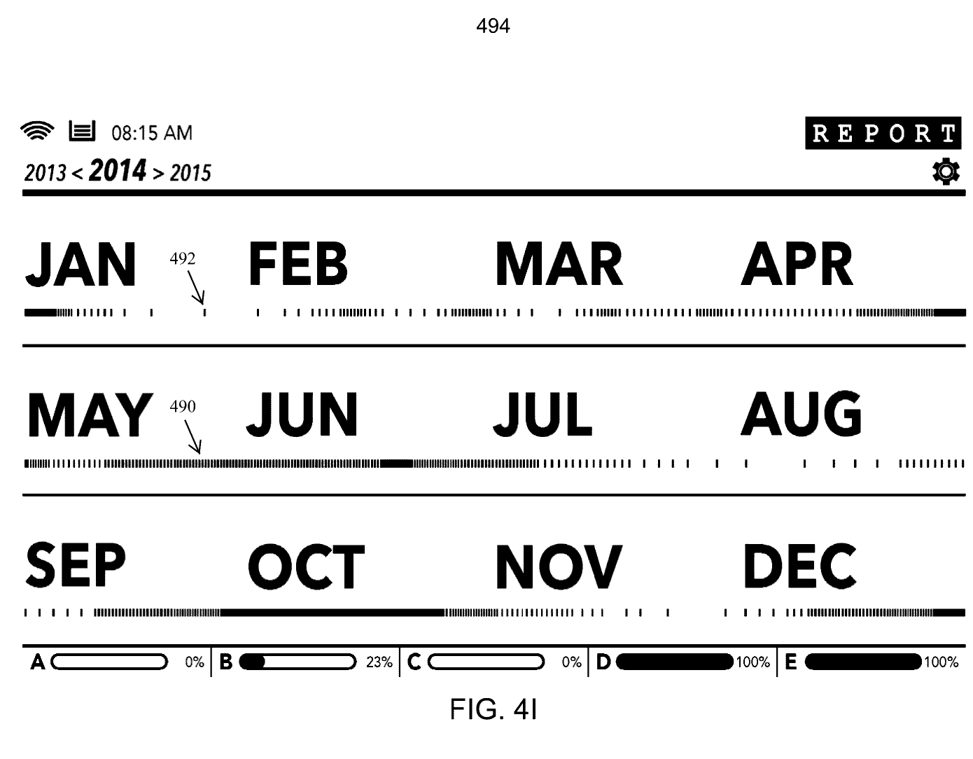

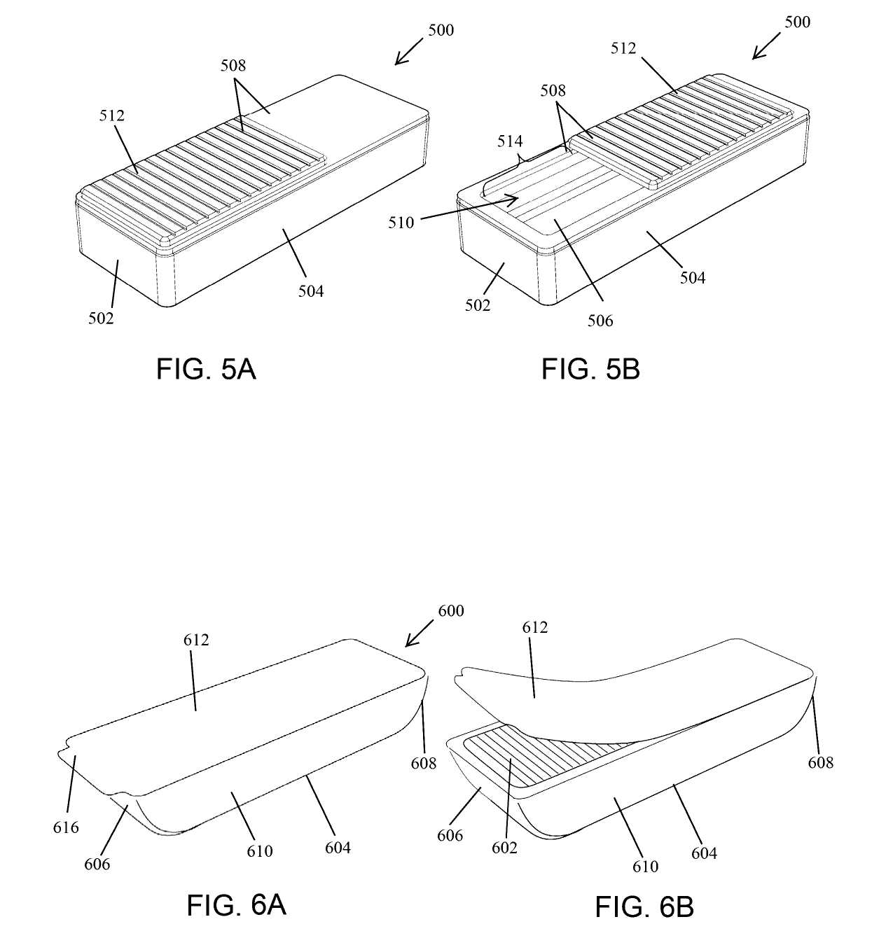

A variation of a pill container suitable for use with a sensor-based medication system is shown in FIGS. 5A and 5B. The pill container 500 includes an anterior wall 502, sidewalls 504, and a posterior wall (not shown) that are flat and perpendicular to a flat bottom 506. A top 508 covers an internal cavity 510 that may hold one or more pills (not shown). At least a portion of the pill container 500 may be movable, reversibly or irreversibly, to open the pill container and allow a user to access pills within the cavity 510. As shown, the top 508 may include a moveable lid 512, which may be slidable to cover and uncover a top opening 514 that may be continuous with the internal cavity 510. FIG. 5A shows the pill container 500 in a closed state with the moveable lid 512 in a closed position, and FIG. 5B shows the pill container in an open state with the moveable lid in an open position, according to one embodiment. While the moveable lid 512 is shown as slidable, it should be appreciated that any reversible or irreversible lid mechanism may be used, such as a hinge mechanism, a press-fit mechanism, a screw mechanism, or the like. Also, while the moveable lid 512 is shown as sliding to open only a portion of the top 508, it should be appreciated that a moveable lid may open any portion or the entire top of a pill container.

FIGS. 6A and 6B depict another variation of a pill container. The pill container 600 may include an internal cavity or space bounded by a bottom 604, an anterior wall 606, a posterior wall 608, sidewalls 610, and a moveable lid 602, wherein the anterior wall 606 and posterior wall 608 have convex outer surfaces and concave inner surfaces, in contrast to the pill container in FIGS. 5A and SBAs shown, a removable seal, film or cover 612 positioned over at least a portion of the moveable lid 602. In some variations, the removable 612 may further secure the contents of the pill container 600 during storage or shipment, until the pill container is ready for use. At the time of use, the cover 612 may be removed prior to placement into the device. The removable cover 612 may serve one or more additional or alternative purposes, such as providing a seal that may indicate if the pill container 600 has been opened or otherwise tampered with prior to its intended use. FIG. 6A shows the removable 612 attached to the pill container 600 substantially covering the moveable lid 602, and FIG. 6B shows the removable cover 612 partially removed from the pill container 600 partially exposing the moveable lid 602, according to one embodiment. The removable cover 612 may be removed in any suitable fashion, such as by peeling, sliding, or breaking a frangible connection between the removable cover and another portion of the pill container. In some variations, the removable cover 612 may include one or more features that may allow a user to grasp and remove the removable cover, such as a tab 616.

As shown in FIGS. 6A and 6B, the anterior and posterior walls 606, 608 of the pill container 600 may be curved and the sidewalls 610, bottom 604, and moveable lid 602 may be flat. However, a pill container may include walls, a bottom, and a top or lid with any curve or curves and that form any suitable angle where two or more sides and/or walls meet. The size and shape of the pill container may be complementary to the size and shape of at least a portion of a receptacle, such as a pill container region, where the pill container may be stationed. For example, the outer convex curves (i.e., the inner concave curves) of the anterior and/or posterior walls 606, 608 of the pill container 600 shown in FIGS. 6A and 6B may have corresponding and complementary shapes and sizes to the concave curves of anterior and/or posterior walls of an electronic pillbox receptacle.

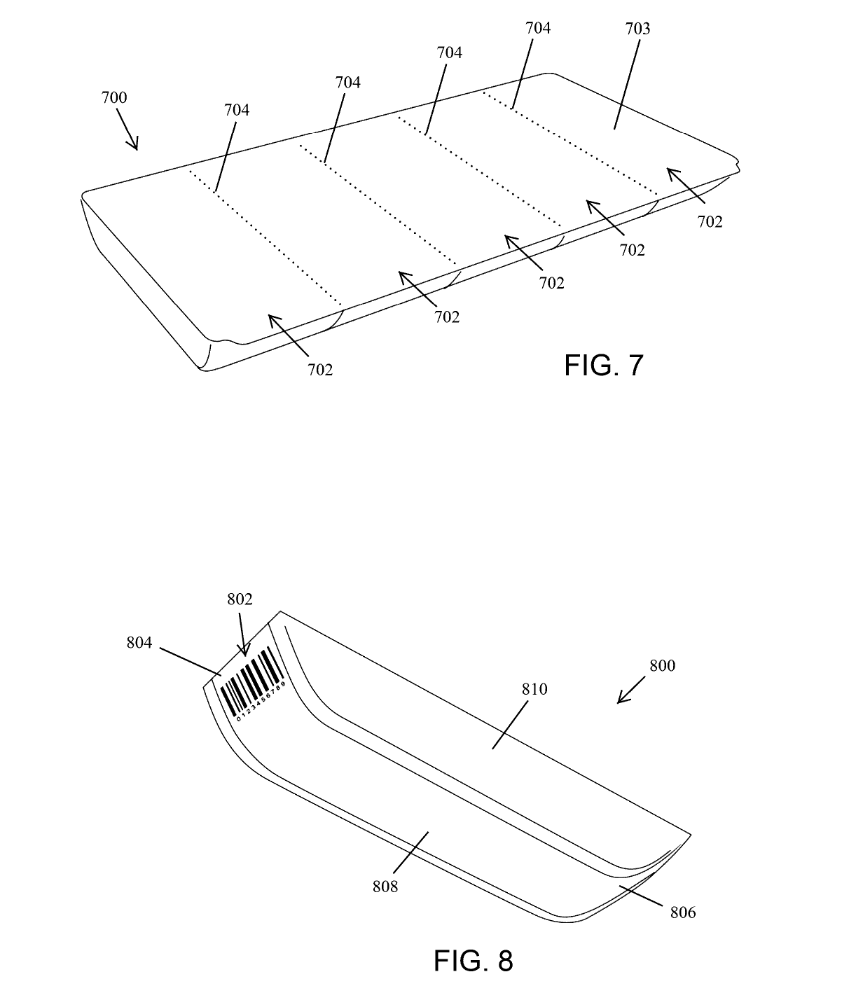

FIG. 7 shows a set of pill containers that may be packaged together, according to one embodiment. As shown, the pill container set 700 includes more than one individual pill container 702 that may at least temporarily share a removable cover 703. In some variations, the pill container set 700 may be configured with so that the entire set is placed together into the device upon removal of the cover 703 spanning all of the individual pill containers 702. In some examples, the sidewalls of adjacent pill containers 703 may be attached such that the pill containers 702 form a unitary structure or tray. In other variations, the sidewalls of the individual pill containers may not be directly attached, and upon removal of the cover 703 spanning all of the pill containers, the individual pill containers may be placed separately or independently into the device. In some further variations, the pill containers 702 and/or cover 703 may include scoring, perforations 704, or is otherwise configured so that an individual pill container and/or associated cover 703 may be separated from the other pill containers and/or covers 703, and may be configured to do so without compromising the seal integrity of the other pill containers and their associated covers 703.

In some variations, a pill container may include more than one internal cavity or sub-cavity. In some variations, the sub-cavities may permit multiple different medications to be stored within an individual pill container. This may be useful for complex medication regimens comprising larger number of medications, e.g. 6, 7, 8, 9, 10, 11, 12, 13, 14 or 15 or more different medications. For example, each elongate pill container may include two, three, four or more sub-cavities, and the sensor system may be configured with sensors in the bottom wall configured to detect activity in each of the individual sub-cavities, independent of the other sub-cavities. This sub-cavity configuration may allow pills to be separated based on one or more pill characteristics, such as the medication type, the dosage amount, the time when the pill is taken, or whether the pills are scheduled dosages or a dosage that is taken as needed. While pills with different characteristics may be separated (e.g., with internal dividing walls), containing them all in a single pill container may, for example, allow pills to be grouped by indication (e.g., by disease, by symptom), result in more efficient and cost-effective packaging (e.g., by using less material), facilitate interaction with an electronic pillbox (e.g., facilitate proper positioning of the pill container in a receptacle), improve compliance (e.g., by refilling all medications when one is refilled), and/or the like.

In some variations, a pill container may include one or more features to allow a sensor system of the electronic pillbox to detect objects and/or movement within or in the vicinity of the pill container. For example, at least a portion of the pill container may be transparent or translucent, such as at least a portion of a bottom, a posterior wall, and/or an anterior wall. Additionally or alternatively, a pill container may include an identifier that may be detected by the sensor system. An identifier may convey specific information about the pills contained in the pill container, such as the generic name and/or trade name, prescribed dose, dosage schedule, side effects, warnings, drug interactions, expiration date, and/or the like. Information may be obtained by the electronic pillbox directly from the identifier and/or indirectly from the identifier. For example, information obtained from the identifier may be used to obtain further information from the electronic pillbox's memory or from a remote server. An identifier may be any pill or pill container specific code, pattern, or signal including, but not limited to barcodes (e.g., linear barcodes, two dimensional or matrix barcodes), identifying numbers (e.g., National Drug Codes), RFID tags, identifying text (e.g., standard identifying text on a pill container), and/or the like. The pill container 800 shown in FIG. 8 includes an identifier 802 in the form of a barcode and identifying numbers, according to one embodiment. As shown, the identifier 802 is positioned on a posterior wall 804 of the pill container 800, but one or more identifiers may be located on any suitable portion or portions of the pill container (e.g., the anterior wall 806, bottom 808, sidewall 810, top, internal surface, at least partially within a wall).

### Methods

The methods described here may facilitate safe and compliant self-administration of medication using a sensor-based medication system. Generally, a user may place one or more pill containers into a receptacle of an electronic pillbox. The electronic pillbox may include a sensor system, which may be configured to detect identifiers on the one or more pill containers. The identifier, which may be a barcode, identifying number, RFID tag, identifying text, or the like, may provide information about the pill container and/or the pills contained in the pill container. In some variations, the electronic pillbox may communicate with a remote server to obtain at least some information related to the pill container and/or pills. The information obtained may include the generic name and/or trade name, prescribed dose, dosage schedule, side effects, warnings, drug interactions, etc. In some variations, a user may manually confirm information that has been obtained automatically by the electronic pillbox and/or enter information related to a pill container that the electronic pillbox was unable to obtain.

The information obtained by the electronic pillbox may be used to improve the safety and compliance of medication administration. For example, the electronic pillbox may remind a user when medication is due to be taken and provide instructions on which medication and what dose should be taken. The electronic pillbox may be configured to alert a user, for example, if medications inserted into the electronic pillbox interact, if the user is allergic to an inserted medication, if the wrong medication is removed from a pill container, and/or if a pill container should be refilled. When a user removes one or more pills from a pill container, the electronic pillbox may detect this removal with one or more sensors. The electronic pillbox may be configured to use this and/or other information to track the number of pills remaining in each pill container.

The electronic pillbox may track a user's medication compliance and it may be configured to display this information on one or more screens of a visual display. The electronic pillbox may include one or more communication modules that may enable it to communicate with remote devices and/or servers. The electronic pillbox may therefore be capable of providing information to a healthcare provider or pharmacy, such as compliance information and pill container refill requests. The electronic pillbox may also be configured to receive information from remote sources, such as detailed medication information and software and/or firmware updates.

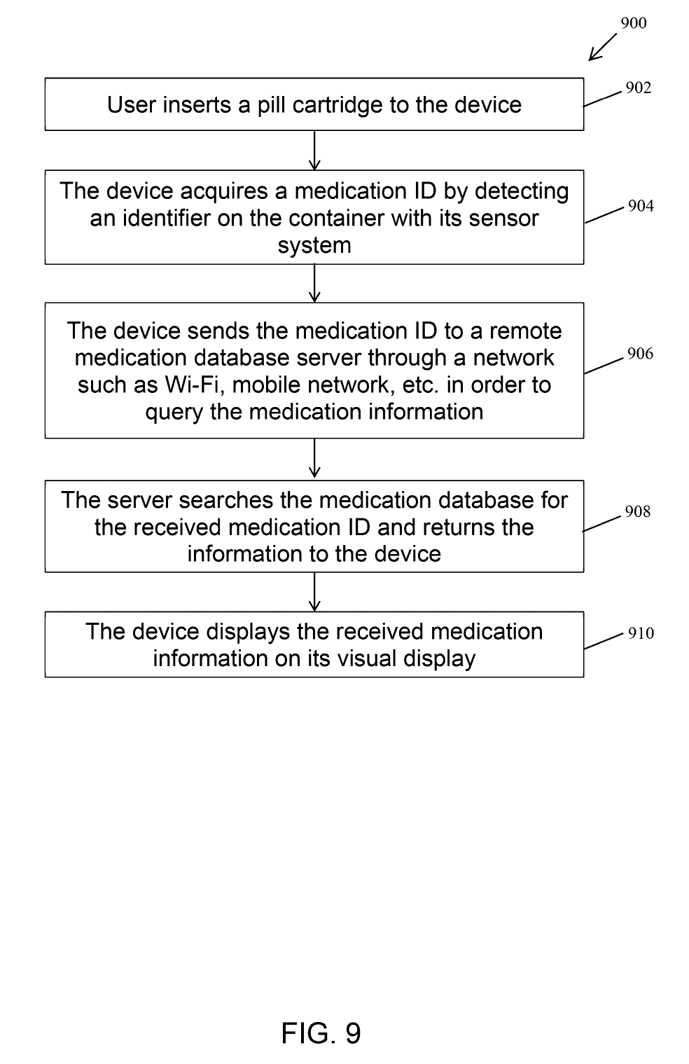

FIG. 9 illustrates a method 900 that may be used by the electronic pillbox for obtaining detailed medication information, according to one embodiment. A user may insert a pill container into the electronic pillbox 902, and this may position the pill container in the vicinity of one or more sensors of the electronic pillbox sensor system. As shown in box 904, the sensor system may detect an identifier on the pill container, which may allow the electronic pillbox to acquire a unique medication ID for the pills contained in the pill container. For example, the sensor system and/or a control system configured to receive input from the sensor system may obtain the medication ID from the identifier.

The electronic pillbox may send the unique medication ID to a remote medication database server through a network such as Wi-Fi or a mobile network 906. More specifically, the electronic pillbox may include one or more communication modules that may be configured to communicate with remote servers and devices. The communication modules may receive information from the control system, such as the medication ID, and send it to the remote medication database server. As shown in box 908, the server may search the remote medication database for the medication ID. The server may send any relevant medication information back to the electronic pillbox via one or more of the communication modules. The electronic pillbox may share the received medication information with the user, such as by displaying at least some of the medication information on a visual display 910.

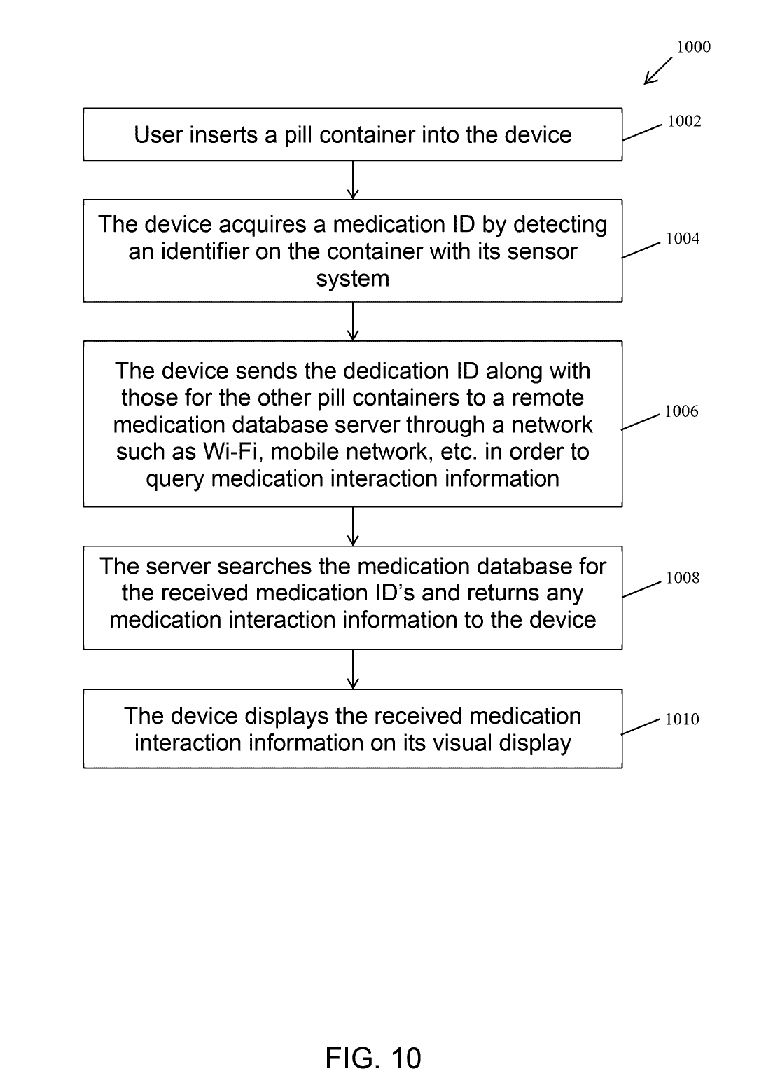

FIG. 10 illustrates a method 1000 for identifying interactions between medications stored in an electronic pillbox, according to one embodiment. Similar to the method described with respect to FIG. 9, a user may insert a pill container into the electronic pillbox 1002, and the electronic pillbox may acquire a medication ID by detecting an identifier on the pill container 1004. Specifically, a sensor system of the electronic pillbox may be configured to detect a pill container identifier, such as a barcode, RFID tag, or other unique code. The medication ID may be determined by the sensor system or by a control system that receives input from the sensor system. Medication IDs may be similarly acquired for every pill container inserted into the electronic pillbox. The electronic pillbox may send the medication IDs for all of the inserted pill containers to a remote medication database server via a network such as Wi-Fi, a mobile network, or the like in order to query medication interaction information 1006. As mentioned with respect to FIG. 9, one or more communication modules of the electronic pillbox may facilitate the exchange of information with a remote server. The server may search the medication database for the received medication IDs in order to identify any interactions between the medications in the electronic pillbox. If any interaction information is found, the server may return the information to the electronic pillbox 1008. If it is determined that there are one or more interactions between the medications in the electronic pillbox, the electronic pillbox may provide this information to a user via a visual display 1010.

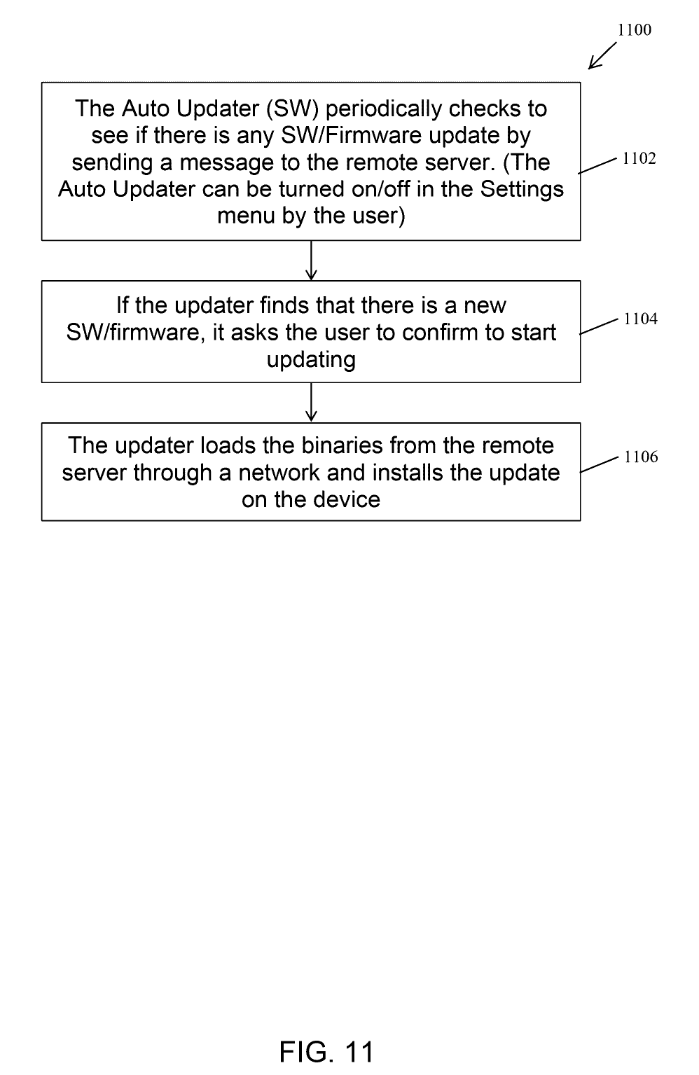

FIG. 11 illustrates a method 1100 for updating software and/or firmware of the electronic pillbox, according to one embodiment. The electronic pillbox may include auto updater software to facilitate this method. As described in box 1102, the auto updater may check for software and/or firmware updates periodically (e.g., every day, every week, every month, every time the device is powered on). In order to check for updates, the auto updater may send a message to a remote server via one or more communication modules. Of note, a user may disable auto updates, such as by changing a setting in a settings menu that may be accessed through the visual display. If the auto updater determines that there is a new software and/or firmware update, it may prompt the user to confirm the update 1104. For example, a confirmation message may appear on the visual display, and the update may not proceed unless the user approves the update. If the user confirms the update, the auto updater may download the update via a network (e.g., the Internet, an intranet, a wireless network) and facilitate its installation on the electronic pillbox 1106.

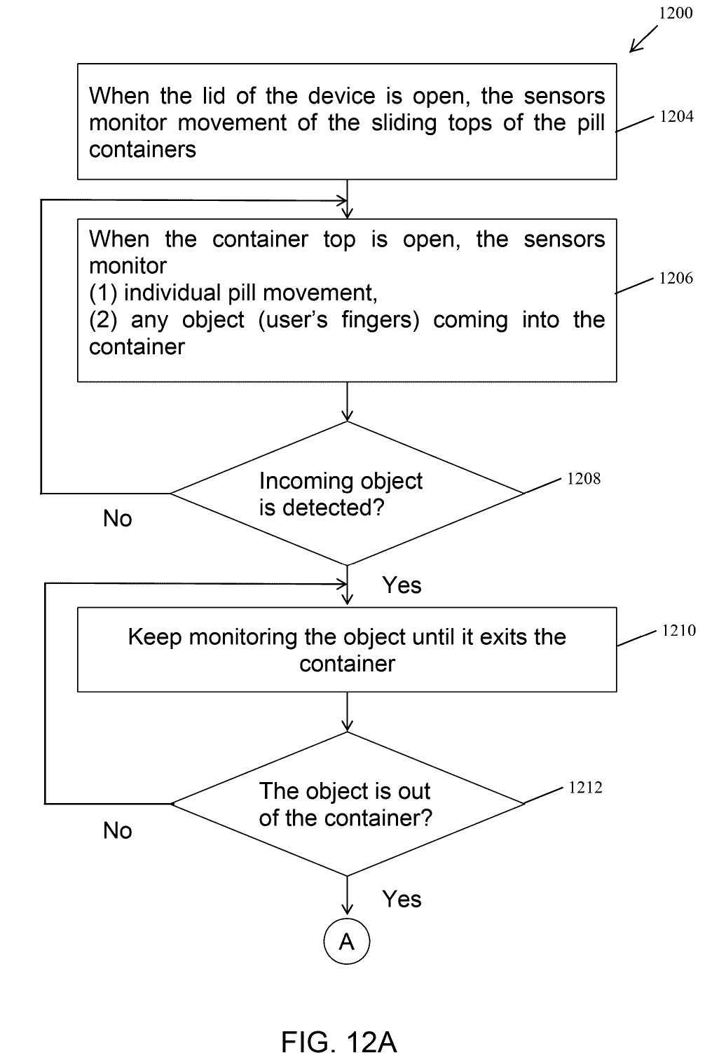

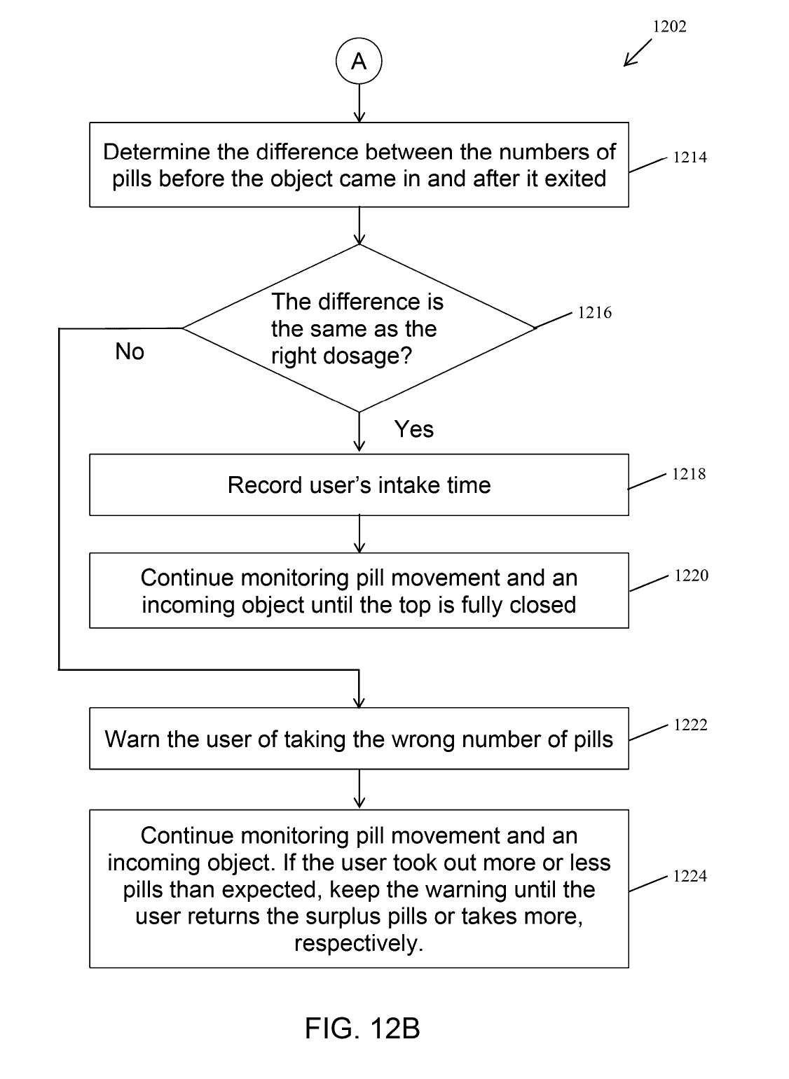

FIG.12A illustrates a method 1200 for determining if one or more pills have been removed from a pill container, and FIG. 12B illustrates a method 1202 for responding when one or more pills have been removed. When a lid of the electronic pillbox is open, a sensor system of the electronic pillbox may be configured to monitor movement of pill container tops, which may or may not be slidable 1204. In some variations of pill containers, the top must be moved in order to access pills inside the pill container, so movement of the top may indicate that the pill container is being opened. When a pill container top is opened, the sensor system may monitor for individual pill movement and insertion of an object, such as a user's finger, into the pill container 1206. If the sensor system detects an object coming into the pill container 1208, then the sensor system may monitor the object until it exits the container 1210. In some variations, one or more motion sensors and/or proximity sensors may detect pill movement and/or an incoming object.

If the sensor system detects that an object, such as a user's finger, has been removed from the container 1212, it may be an indication that one or more pills has been removed as well. As shown in FIG. 12B, if the object exits the pill container, the electronic pillbox may determine the difference between the number of pills in the pill container before the object entered and after the object exited 1214 to calculate how many pills were removed. In some variations, at least a portion of the pill container may be transparent, which may allow one or more sensors, such as optical sensors or camera elements to detect and count pills in the pill container. If the electronic pillbox determines that the number of pills removed is the same as the number of pills that should be taken by the user (i.e., an expected dose) 1216, then the electronic pillbox may record the intake time 1218 in order to track compliance. The sensor system of the electronic pillbox may then continue to monitor for pill movement and for insertion of an object into the pill container until the top of the pill container is closed 1220. However, if the electronic pillbox determines that the number of pills removed is different than the expected dose, the electronic pillbox may warn the user that the wrong number of pills was taken 1222. For example, a warning screen may appear on the visual display. In this situation, the sensor system of the electronic pillbox may continue monitoring for pill movement and insertion of an obj ect into the pill container, but the electronic pill container may continue to display a warning until the user returns extra pills or takes more to reach the expected dose 1224.

### Sensor-Based Container

Many of the principles described herein with respect to a sensor-based electronic pillbox may be applied to containers configured to hold contents other than medication. For example, a sensor-based container may include one or more sensors configured to monitor one or more characteristics of the contents of the container. For example, a sensor-based container may be configured to monitor a color, opacity, viscosity, movement, and/or quantity of a solid, liquid, and/or gas. Monitoring the contents of a container may be especially useful when the contents are volatile, perishable, or otherwise at risk of changing states. The sensor-based container may be configured to exchange information wirelessly via Wi-Fi, Bluetooth, and the like with one or more external servers and/or devices (e.g., computer, mobile phone, tablet). In response to one or more signals detected by the sensors or to one or more signals received from an external server or device, the sensor-based container may provide visual, audio, and/or tactile output.

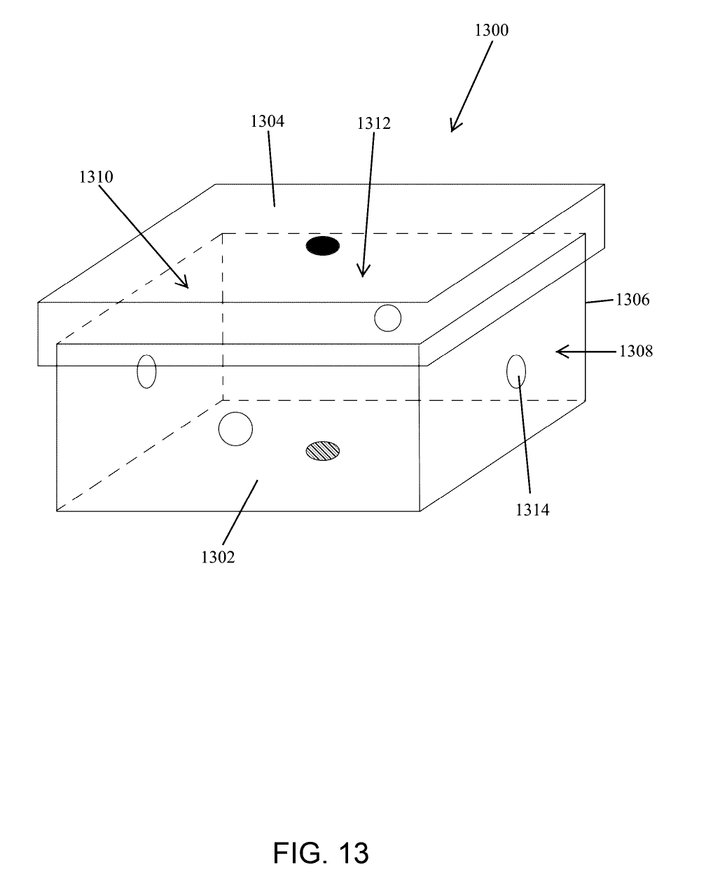

FIG. 13 depicts a sensor-based container according to one embodiment. As shown, the sensor-based container 1300 includes a base 1302, an optional top 1304, and sidewalls 1306 with an outer surface 1308, an inner surface 1310, and a cavity 1312 surrounded by the inner surface. One or more sensors 1314, such as lensless smart sensors with built in light or other optical sensors, may be coupled to the wall 1306 and face into the cavity 1312. Other sensors may be configured to face outward, while still other sensors may not require an inward or outward orientation. The sensor-based container may also include a processor, internal memory, display and audio components, an electronic communication module configured to send and receive remote information corresponding to the contents of the container, and/or a controller configured to selectively provide a notification corresponding to the remote information. A power supply system, such as a battery powered system with wireless charging may be incorporated into the container.

While invention has been particularly shown and described with references to embodiments thereof, it will be understood by those skilled in the art that various changes in form and details may be made therein without departing from the scope of the invention. For all of the embodiments described above, the steps of the methods need not be performed sequentially.

1. A medicament system, comprising:
a pill container storage unit, the unit comprising:
a base with at least one receptacle configured to receive at least one pill container;
a lid with an external surface and an internal surface, the lid configured to reversibly open and close to cover the at least one receptacle;
a sensor system;
a visual display; and
a control system configured to receive sensor input from the sensor system and provide output to the visual display;
wherein the sensor system is configured to detect:
presence or absence of the at least one pill container in the at least one receptacle;
movement within at least one pill container, when the at least one pill container is stationed in the at least one receptacle; and
an open or closed state of at least one of the lid and the at least one pill container.

2. The medicament system of claim 1, wherein the sensor system is further configured to detect an amount of pills in the at least one pill container or an identifier associated with the at least one pill container.

3. The medicament system of claim 1, wherein the sensor system is further configured to obtain pill information from the at least one pill container.

4. The medicament system of claim 1, wherein the sensor system comprises at least one sensor located in an anterior wall of the at least one receptacle to detect the movement within the at least one pill container when the at least one pill container is stationed in the at least one receptacle.

5. The medicament system of claim 1, wherein the sensor system further comprises at least one posterior optical sensor in a posterior wall of the at least one receptacle to read an identifier associated with the at least one pill container when placed in one of the at least one receptacles.

6. The medicament system of claim 1, wherein the sensor system further comprises a camera element located on the lid, wherein the camera element is configured to detect at least one of:
the open or closed state of the lid;
the presence or absence of the at least one pill container in the at least one receptacle;
an identifier associated with the at least one pill container;
a signal corresponding to pill removal from the at least one pill container or to pill intake by a user; and
a hand location or a mouth location of a user.

7. The medicament system of claim 6, wherein the signal corresponding to the pill removal is a signal corresponding to movement in the at least one pill container while the at least one pill container is stationed in the at least one receptacle.

8. The medicament system of claim 1, wherein the sensor system comprises an ambient light sensor.

9. The medicament system of claim 1, wherein the sensor system comprises sensors located in a bottom wall and an anterior wall of the at least one receptacle to detect the movement within the at least one pill container when the at least one pill container is stationed in the at least one receptacle.

10. The medicament system of claim 9, wherein said sensors are configured to detect the open or closed state of the at least one pill container.

11. The medicament system of claim 1, wherein the sensor system comprises at least one mechanical sensor located in the at least one receptacle, wherein said at least one mechanical sensor is configured to detect the presence or absence of the at least one pill container in the at least one receptacle.

12. The medicament system of claim 1, wherein the display is located on the inner surface of the lid.

13. The medicament system of claim 1, wherein the container storage unit further comprises an external indicator on an external surface of the base or the external surface of the lid, the indicator comprising an optical indicator or a tactile indicator.

14. The medicament system of claim 1, wherein the visual display comprises a first edge configured with a first edge length that spans across at least a portion of each of the at least one receptacles.

15. The medicament system of claim 1, wherein the visual display is a touchscreen display, and the sensor system comprises an RFID or optical sensor with a refractive or diffractive element.

16. The medicament system of claim 1, wherein the sensor system comprises at least one optical sensor located in a bottom wall of the at least one receptacle, and wherein the at least one optical sensor located in the bottom wall is configured to detect the at least one of the presence and absence of the at least one pill container in the at least one receptacle, and the movement within the at least one pill container when stationed in the at least one receptacle.

17. The medicament system of claim 1, further comprising a communication module configured to communicate with a remote server or a separate computing device.

18. A container, comprising:
a wall with an outer surface, an inner surface, and cavity surrounded by the inner surface;
an optical sensor with a diffractive grating, wherein the optical sensor is coupled to the wall and facing into the cavity, wherein the sensor is configured to optically detect at least one characteristic of content of the cavity;
an electronic communication module configured to send and receive remote information corresponding to the content; and
a controller configured to selectively provide a notification corresponding to the remote information.

19. The container of claim 18, wherein the notification is an electronic notification sent by the electronic communication module to a wireless communication device or an optical notification mounted on the outer surface of the wall.

20. The container of claims 19, wherein the at least one characteristic comprises at least one of a fluid viscosity, movement of any contents of the cavity, a fluid opacity, a fluid level, and a fluid color.

21. A method of managing treatment, comprising:
detecting an opening of an electronic pillbox; and
providing a visual display inside the electronic pillbox indicating a pill container region from a plurality of pill container regions in the pillbox to take a pill.

22. The method of claim 21, further comprising providing an external notification from an electronic pillbox to a user to take a pill.

23. The method of claim 21, wherein the visual display further indicates the number of pills to take from the pill container region.

24. The method of claim 21, further comprising:
detecting a signal indicative of the amount of pills in a pill container region;
providing information on the visual display corresponding to the signal;
detecting placement of a pill container into a pill container region;
detecting an identifier associated with the pill container; and
detecting movement within the pill container region indicative of pill removal from the pill container region using a sensor array located about the pill container region.

25. The method of claim 21, further comprising providing a calibration to the signal indicative of the amount of pills in a pill container region, wherein the calibration corresponds to the identifier.
